(19) United States
(12) Patent Application Publication
(10) Pub. No.: US 2026/0227752 A1
(43) Pub. Date: Aug. 6, 2026

(54) CONTROL DEVICE, METHOD AND COMPUTER PROGRAM PRODUCT

(71) Applicant: Astemo, Ltd., Tokyo (JP)

(72) Inventors: Takehito OGATA, Schwaig-Oberding (DE); Masato IMAI, Tokyo (JP); Keiichiro NAGATSUKA, Hitachinaka-shi, Ibaraki (JP); Masashi SEIMIYA, Hitachinaka-shi, Ibaraki (JP); Maung-Maung AYE, Schwaig-Oberding (DE)

(73) Assignee: Astemo, Ltd., Tokyo (JP)

(21) Appl. No.: 19/147,921

(22) PCT Filed: Oct. 24, 2023
(86) PCT No.: PCT/JP2023/038267

§ 371 Date: Jul. 14, 2025

(30) Foreign Application Priority Data
Jan. 16, 2023 (DE) 10 2023 200 278.7

(51) Int. Cl. G05B 13/04; G08G 1/16

(52) U.S. Cl. CPC G05B 13/048; G08G 1/16

(57) ABSTRACT

The present subject matter relates to control device, a method and a computer program product for controlling a driver assistance system for a vehicle. The control device comprises a first measuring device determining a plurality of first obstacle parameters of a detected obstacle and is connected to a second measuring device determining a plurality of second obstacle parameters of the detected obstacle. The control device further comprises an obstacle parameter calculating unit 104 configured to receive the plurality of first and second obstacle parameters, and to calculate a plurality of third obstacle parameters of the detected obstacle based on the plurality of first and second obstacle parameters. The control device further comprises a unit 105 configured to calculate a first decision parameter based on the plurality of third obstacle parameters, and to enable a driver assistance if the first decision parameter is lower than a predetermined activation threshold.

### TECHNICAL FIELD

The present subject matter relates to control device, a method and a computer program product for controlling a driver assistance system for a vehicle.

### BACKGROUND ART

Current advanced driver assistance systems (ADAS) use on-board sensors mounted on a vehicle to detect obstacles in an area surrounding the vehicle and intervene in case of a risk of collision. To avoid false triggering, the obstacles are observed/detected several times in succession before an intervention is activated. This allows, e.g., to increase the reliability of a calculation of the position and speed of the detected obstacle. However, the repeated detections require a certain observation time, which may, for example, then cause the ADAS to brake heavily, which can result in a feeling of discomfort for the driver of the vehicle. Such a situation may occur in particular if an obstacle suddenly emerges from a blind spot in front of or behind the vehicle. A possibility to mitigate such a situation is to use V2X (vehicle to everything) communication to obtain information beyond the detection range of the vehicle's on-board sensors.

Patent Literature 1 describes a system and an apparatus for detecting a moving object entering a field of view of a camera device of a vehicle. The system uses position information acquired from a vehicle's own positioning device mounted on the vehicle and position information periodically received from a mobile terminal possessed by the moving object. Based on the position information of the mobile terminal of the mobile unit and the vehicle's own direction of travel, an area for detecting the mobile unit is set in an image captured by the camera once the moving object has entered the field of view of the camera, and the mobile unit is detected.

### CITATION LIST

### Patent Literature

Patent Literature 1: WO 2015/098510 A1

### SUMMARY OF INVENTION

### Technical Problem

However, a direct control of an ADAS by an external device is difficult, because it is essential to avoid false activation of the latter due to delays, transmission instabilities, and malicious transmission of V2X information. Therefore, it is important to evaluate the V2X information (e.g. in view of specification and application range of an external device) and use only suitable parameters of the V2X information for initiating an ADAS function.

The herein described subject matter addresses the technical object of improving the driving comfort of a vehicle equipped with a driver assistance system while at the same time increasing the reliability of the driver assistance functions. This object is achieved by the subject matter of the independent claims. Further preferred developments are described in the dependent claims.

Solution to Problem According to the subject matter set forth in the appended claims, there is proposed a control device, a method and a computer program product for controlling a driver assistance system for a vehicle. In particular, the subject matter disclosed herein improves the characteristics of a driver assistance system in the event of sudden obstacles occurring in an area surrounding the vehicle.

The driver assistance system to be controlled by the disclosed subject matter may be, for example, an automatic emergency braking (AEB), an adaptive cruise control (ACC) or a lane change assist (LCA). Other types of driver assistance systems may also be combined with the proposed subject matter.

The control device comprises a first obstacle parameter acquisition unit configured to receive a plurality of first obstacle parameters of an obstacle in an area surrounding (the vicinity which may include a range from centimetres to a plurality of meters and up to a few kilometers) the vehicle that is detected by a first measuring device, the plurality of first obstacle parameters including one or more parameters of a first category and one or more parameters of a second.

The first measuring device may be a radar (radio detection and ranging) sensor, a camera sensor, a lidar (light detection and ranging) sensor, a sonar (sound navigation and ranging) sensor, a GNSS (global navigation satellite system) sensor or any other sensor suitable for detecting obstacles in an area surrounding a vehicle. The first measuring device may be connected to or integrated with or part of the vehicle. The obstacle may be, for example, a pedestrian, a bicycle, another vehicle or any other object emerging in the surroundings of the vehicle when the vehicle is traveling along a road. The plurality of first obstacle parameters may include, for example, obstacle type (bicycle, pedestrian etc.), position, heading, velocity, yaw rate and acceleration of the obstacle detected by the first measuring device or any other type of parameter describing characteristics of the obstacle.

The first measuring device (also named sensor or on-board sensor or on-board device) may be part of the control device or may be external thereto. For example, if the control device is a separate control unit or a control unit integrated with another control unit of the vehicle, it may receive signals/data from the first measuring device which may be provided at a different location/position of the vehicle. Alternatively, the first measuring device may be integrated with the control device as described herein; and in an even further modification the first obstacle parameter acquisition unit and the first measuring device may be integrated with each other as a single unit so that the functions of the two units described in this disclosure would be performed by said integrated single unit.

In this context, a first obstacle parameter shall be understood as a parameter of the object detected by the first measuring device. The plurality of first obstacle parameters may be divided into a first group including one or more parameters of a first category and a second group including one or more parameters of a second category. The category of a parameter may be defined, for example, by a characteristic/attribute/property that one parameter may have in common with another parameter.

Furthermore, the control device comprises a second obstacle parameter acquisition unit configured to receive a plurality of second obstacle parameters of an obstacle in an area surrounding the vehicle that is detected by a second measuring device. The second measuring device (or sensor or external sensor) is provided outside the vehicle in which the first measuring device is located. The plurality of second obstacle parameters including one or more parameters of the first category and one or more parameters of the second category. The second obstacle parameter acquisition unit is preferably part of the herein described control device and receives the data/signals from the second measuring device to at least receive them in the control device and forward them to the next unit, preferably the obstacle parameter calculation unit. However, in case the second obstacle parameter acquisition unit should be omitted in an alternative configuration of the herein described control device, the second measuring device, placed outside the vehicle in which the first measuring device and/or the control device as described herein is provided, may directly send second obstacle parameters to the obstacle parameter calculation unit.

A second obstacle parameter shall be understood as a parameter of the detected obstacle determined/detected/measured by the second measuring device or the second obstacle parameter acquisition unit. The plurality of second obstacle parameters may also include, for example, obstacle type, position, direction (heading), velocity, yaw rate and acceleration of the obstacle detected by the first measuring device or any other type of parameter describing characteristics of the obstacle, and may also be divided into a first group including one or more parameters of a first category and a second group including one or more parameters of a second category. In particular, the second measuring device may determine the same parameters of the first and second category as the first measuring device.

The second measuring device may also be a radar sensor, a camera sensor, a lidar sensor, a sonar sensor, a GNSS sensor or any other sensor suitable for detecting obstacles in an area surrounding a vehicle. The second measuring device may be the same sensor type as the first measuring device or a different sensor type. In particular, the second measuring device may be located at a different place than the first measuring device, so that it may detect an obstacle at a different time than the first measuring device. Preferably, the second measuring device may be located to detect an obstacle earlier than the first measuring device. As noted above, the second measuring device is provided remotely to the vehicle, i.e. it is not integrated or placed at the vehicle but outside thereof.

The one or more parameters of the first category preferably may be parameters that can be determined/measured/detected by the first measuring device (or the first obstacle parameter acquisition unit) more reliably than by the second measuring device (or the second obstacle parameter acquisition unit). Conversely, the one or more parameters of the second category may preferably be parameters that can be determined/measured/detected more reliably by the second measuring device.

For example, if the second measuring device detects an obstacle earlier than the first measuring device, the firstly mentioned (or the second obstacle parameter acquisition unit) can already receive a large number of obstacle parameters before the first measuring device (or the first obstacle parameter acquisition unit) receives a first obstacle parameter. Because of this longer observation time of the obstacle due to the continuous receiving of obstacle parameters, a parameter remaining constant over the observation time can be determined more accurately by the second measuring device.

Similarly, if both measuring devices are of a different sensor type, the characteristics of the two measuring devices may be different. This may also result in the first measuring device being able to determine a parameter of the first category more accurately and the second measuring device being able to determine a parameter of the second category more accurately.

Furthermore, the control device comprises an obstacle parameter calculating unit that receives the plurality of first and second obstacle parameters from the first and second obstacle parameter acquisition units, and calculates a plurality of third obstacle parameters including one or more parameters of the first category and one or more parameters of the second category based on the plurality of first and second obstacle parameters.

In other words, the obstacle parameter calculating unit uses the plurality of first and second obstacle parameters determined by the first and the second measuring device (or the obstacle parameter acquisition units) for calculating a new set of third obstacle parameters. This new set of third obstacle parameters also includes one or more parameters of the first category and one or more parameters of the second category. When calculating the plurality of third parameters, the obstacle parameter calculating unit calculates the one or more parameters of the first category based on the plurality of first obstacle parameters and the one or more parameters of the second category based on the plurality of second obstacle parameters.

In particular, the obstacle parameter calculating unit takes the parameters of the first category, which can be determined more reliably by the first measuring device (or the first obstacle parameter acquisition unit), from the plurality of first obstacle parameters, and the parameters of the second category, which can be determined more reliably by the second measuring device (or the second obstacle parameter acquisition unit), from the plurality of second obstacle parameters for calculating the new set of third obstacle parameters.

By using the most reliable parameters, the obstacle parameter calculating unit is able to calculate the plurality of third obstacle parameters with high accuracy. This also means that the obstacle parameter calculation unit can provide a plurality of reliable obstacle parameters at an earlier time compared to calculating them based only on one measuring device, where it took longer to obtain a reliable value for each obstacle parameter.

As noted above, the control device may include first and second obstacle parameter acquisition units that receive the first and second obstacle parameters from the first and second measurement devices. These obstacle parameter acquisition units may, for example, perform processing of the first and second obstacle parameters determined by the first and second measurement devices (e.g., smoothing, filtering, averaging) before they are transmitted to the obstacle parameter calculation unit. Further, they may also be configured to detect/determine and/or select the relevant parameters of an obstacle which has been detected by the first or second measuring device. In other words, the first/second measuring devices may also be configured to detect an obstacle and the first/second obstacle parameter acquisition units may be configured to process the detection data from the first/second measuring devices to extract/gain the parameters which are used for the further processing within the herein described control device. Even further or alternatively, the first and second obstacle parameter acquisition units may also (merely) serve as receiving and parameter forwarding units within the control device.

Further, the control device comprises an enabling unit (which may also be named driver assistance activation decision unit or driver assistance activation unit or the like) that calculates a first decision parameter based on the plurality of third obstacle parameters received from the obstacle parameter calculating unit, and enables a driver assistance if the decision parameter is lower than a predetermined activation threshold. In other words, the obstacle parameter calculation unit sends the plurality of third obstacle parameters to the enabling unit, which derives a comparison figure (decision parameter) from the third obstacle parameters to decide whether to activate a driver assistance. A driver assistance may be, for example, an automatic braking, accelerating or steering. Alternatively or additionally, a driver assistance can also be an acoustic or visual signal that prompts the driver to perform a certain action, such as braking or deceleration or the like.

The enabling unit then compares the decision parameter with a predetermined activation threshold and enables a driver assistance if the decision parameter falls below the threshold. For example, the enabling unit may calculate a time until the vehicle reaches the obstacle (time-to-collision) or a difference between the vehicle and the obstacle as decision parameter based on the third obstacle parameters. The predetermined activation threshold in this case may be a predetermined time or a predetermined distance.

As the enabling unit derives the first decision parameter from the plurality of third obstacle parameters being based on the most reliable obstacle parameters received from the first and second measuring unit, the enabling unit can determine the first decision parameter with high accuracy at an early time. This allows the control device to activate a driver assistance before an obstacle appears in the immediate vicinity of the vehicle, thus avoiding an abrupt driving operation and increasing driving comfort.

In one example, the control device may additionally comprise an activation unit, which may activate the driver assistance based on an enabling signal received from the enabling unit. In other words, in a case in which the decision parameter has fallen below the predetermined threshold, the enabling unit can send an enabling signal to the activation unit, which then activates actuators/control elements for driver assistance in the vehicle, such as hydraulic valves for braking or steering actuation and/or signal outputs for providing acoustic or visual information. However, it may also be possible that the respective actuators are directly activated by the enabling unit.

According to an example, the obstacle parameter calculating unit may determine if the first and the second measuring device have detected the same (identical) obstacle based on a comparison of at least one of the plurality of first and second obstacle parameters, and may calculate the plurality of third obstacle parameters only if the determination is positive, i.e. the obstacle(s) detected by the first and the second measuring device is/are identical.

For example, the obstacle parameter calculating unit may determine firstly whether the plurality of first and second obstacle parameters include the same obstacle type, for example, whether both measuring devices have detected a bicycle. If this is the case, the obstacle parameter calculating unit may calculate a distance between an obstacle position included in the first obstacle parameters and an obstacle position included in the second obstacle parameters. If the calculated distance is below a predetermined distance threshold, the obstacle parameter calculating unit may identify the obstacle detected by both measuring devices to be the same object. In case of a positive result, i.e. the same, the obstacle parameter calculating unit may use the first and the second plurality of obstacle parameters to calculate the plurality of third obstacle parameters as described above. In case of a negative result, i.e. not the same, the obstacle parameter calculating unit may receive a further plurality of first and/or second obstacle parameters from the first and/or second measuring device and may repeat the process until a positive result is achieved.

According to an example, the first measuring device may be a measuring device that may communicate faster with the obstacle parameter calculation unit (or with the first obstacle parameter acquisition unit) than the second measuring device, but may detect the obstacle later than the second measuring device. Conversely, the second measuring device may be a measuring device that may detect the obstacle earlier than the first measuring device, but may communicate slower/have a longer communication path with the obstacle parameter calculation unit (or with the second obstacle parameter acquisition unit) than the first measuring device.

Preferably, as noted above, the first measuring device may be an on-board measuring device positioned inside the vehicle, while the second measuring device is an external measuring device positioned outside the vehicle. A communication between the on-board measuring device and the control device explained herein (or the first obstacle parameter acquisition unit) may be executed in real-time or with low latency, while a communication between the external measuring device and the control device described herein may be executed, for example, via a cellular network, which is accompanied by a longer latency period.

The on-board measuring device (preferably the first measuring device) may be, for example, a radar sensor, a camera sensor, a lidar sensor, a sonar sensor, a GNSS sensor or any other sensor suitable as on-board sensor for a vehicle. In particular, a combination of radar, camera, lidar, sonar and GNSS sensor may be attached to the vehicle. However, each of these sensors can only detect an obstacle if it appears in its field of view, i.e., if it is not obscured by another obstacle within the vehicle's vicinity. Therefore, a second, external device, which may detect the obstacle earlier can provide second obstacle parameters useful for enabling a driver assistance that will not be surprised and thus can act/can be activated at an early stage.

The external measuring device (preferably the second measuring device) may be, for example, a road side unit which may detect an obstacle, for example, via a radar and/or a camera sensor. In addition, the roadside unit may be configured to exchange information with obstacles equipped with their own on-board measuring devices, such as other vehicles and pedestrians/bicyclists carrying a mobile device. The latter, namely other vehicles with on-board measuring devices and mobile devices (smartphones, tablets, laptops), may also be external measuring devices suitable as second measuring device. In particular, another vehicle in the vicinity of the vehicle may also be an obstacle providing information about its own state, such as current position, speed and heading, and/or only a measuring device providing information about another obstacle in the vicinity of the vehicle detected by its own on-board measuring devices.

In one example, the second measuring device may be an on-board measuring device of another vehicle travelling as potential obstacle in the surroundings of the vehicle. In this case, the obstacle parameter calculation unit may receive a width and a height of the other vehicle as additional second obstacle parameters, and may consider said additional obstacle parameters when calculating the plurality of third obstacle parameters. In particular, the obstacle parameter calculation unit can employ the width and height of the vehicle to determine its spatial position coordinates. Knowing the spatial position coordinates of the obstacle subsequently allows the enabling unit to more accurately determine the collision distance to the obstacle and/or the time-to-collision.

It may also be possible, as noted above, that both, the first and the second measuring devices, are external devices positioned outside the vehicle. In this case, a measuring device located closer to the vehicle may serve as first measuring device and a measuring device located farther from the vehicle may serve as second measuring device. Thus, the measuring device closer to the vehicle has a shorter latency period than the measuring device further away. On the other hand, the measuring device located further away from the vehicle can detect an obstacle earlier than the measuring device located closer thereto.

For example, a road side unit right next to the vehicle may serve as first measuring device and a smartphone of a pedestrian may serve as second measuring device, in a case where the pedestrian with the smartphone appears as obstacle in the surroundings of the vehicle. The control device may receive a signal from each external measuring device and decide, for example, which measuring device should act as the first and second measuring device depending on the signal strength. Subsequently, the obstacle parameter calculating unit (preferably via the first/second obstacle parameter acquisition unit) may receive the first and second obstacle parameters from both external devices and calculate the third obstacle parameters based on the most reliable parameters thereof.

In the present example, the obstacle parameter calculation unit may receive, e.g., a position of the pedestrian as the first obstacle parameter from the road side unit because the latency between the road side unit and the control device is small, which is important for accurately detecting the current position of the pedestrian. On the other hand, the obstacle parameter calculation unit can receive, e.g., a velocity of the pedestrian from their smartphone as a second obstacle parameter, since it can be assumed that the velocity of the pedestrian is almost constant in the observed time slot. As the smartphone has determined the pedestrian's velocity over a much longer period of time than the road side unit, the accuracy and reliability of its determination is increased.

According to an example, a parameter of the first category may be a position parameter of the obstacle including static information about the obstacle and a parameter of the second category may be a movement parameter of the obstacle including dynamic information about the obstacle. Static information about the obstacle may be, for example, the type of obstacle (pedestrian, bicycle, vehicle, etc.), the current time at which the obstacle is detected (time stamp), and its current position and heading. In particular, a static information is characterized by the fact that it is not time-dependent at the time of acquisition. Dynamic information about the obstacle may be, for example, its velocity, yaw rate and acceleration. In particular, a dynamic information is characterized by the fact that it is time-dependent at the time of acquisition.

Since a position parameter, such as position and heading of the obstacle may change its value each time it is determined by the first and second measuring devices, it is important that it be transmitted immediately to the obstacle parameter calculation unit so that the latter may obtain a current value of the position parameters. The first measurement device may provide the plurality of first obstacle parameters within a short latency period, so that the obstacle parameter calculation unit may use the position parameters received from the first measurement device to calculate the plurality of third position parameters.

However, a movement parameter, such as velocity, acceleration and yaw rate of the obstacle can be assumed to remain constant within the observed time slot. Therefore, the transmission time of a movement parameter to the obstacle parameter calculation unit may be less important than in the case of the transmission of a position parameter. On the other hand, the reliability of an obstacle parameter increases with every determination, i.e., the earlier a constant obstacle parameter can be determined, the higher its accuracy and reliability. As the second measuring device may detect the obstacle earlier than the first measuring device, the obstacle parameter calculation unit may use the movement parameters received from the second measurement device to calculate the plurality of third position parameters.

In this way, it is ensured that the obstacle parameter calculation unit may calculate the plurality of third obstacle parameters, based on which a driver assistance may be activated, using the first and second obstacle parameters with the highest accuracy and reliability.

According to an example, the obstacle parameter calculating unit may include a prediction model for calculating the plurality of third obstacle parameters that may use the one or more parameters of the second category from the plurality of second obstacle parameters as one or more initial parameters to calculate the plurality of third obstacle parameters when the obstacle is detected for the first time. In other words, the prediction model may use the movement parameters of the plurality of second obstacle parameters for initializing the prediction model. Thus, the prediction model is able to start a calculation having already reliable values, e.g., for velocity, acceleration and yaw rate, which improves the accuracy of the prediction. In particular, the prediction model may include a Kalman filter for calculating the plurality of third obstacle parameters based on the plurality of first and second obstacle parameters determined by the first and second measuring device.

According to an example, the obstacle parameter calculating unit may calculate a confidence indicator expressing a confidence of the plurality of third obstacle parameters, and may send the calculated confidence indicator to the enabling unit together with the third obstacle parameters. The confidence indicator may be, for example, a counter which may be incremented each time an event occurs that increases the reliability of a third obstacle parameter, and which may be decremented each time an event occurs that decreases the reliability of a third obstacle parameter. In this case, the enabling unit may enable the activation of the driver assistance if the first decision value is lower than the predetermined activation threshold and if a value of the confidence indicator is higher than a first predetermined confidence threshold. This ensure that a driver assistance is only performed if the plurality of third obstacle parameters, based on which the decision value for activating a driver assistance is calculated, provide sufficient reliability.

According to an example, the enabling unit may additionally receive the plurality of first obstacle parameters and may calculate a second decision parameter based on the plurality of first obstacle parameters. In this case, the enabling unit may activate the driver assistance if the first and/or the second decision parameter is lower than the predetermined activation threshold.

In other words, the enabling unit may calculate two decision parameters, the first being derived from the plurality of third obstacle parameters calculated by the obstacle parameter calculation unit based on the plurality of first and second obstacle parameters as described above, and the second being derived only from the plurality of first obstacle parameters. By enabling the driver assistance if at least one of the two decision parameters is lower than the predetermined threshold, it is ensured that a driver assistance can be reliably activated even if the control unit only has access to a first measuring device, such as an on-board sensor of the vehicle.

According to an example, the obstacle parameter calculating unit may increase the value of the confidence indicator based on a number of times the obstacle is detected by the first measuring device. Due to the fast communication path of the first measuring device, wherein stable signal transmission is assumed, the reliability of the plurality of first obstacle parameters may be regarded as mainly depending on the observation time, i.e. the number of times the obstacle is detected by the first measuring device, which may be much shorter than the observation time of the second measuring device detecting the obstacle earlier.

According to an example, the obstacle parameter calculating unit may calculate the confidence indicator considering a specification of the plurality of second obstacle parameters determined by the second measuring device. Since the second measuring device may be much more remote from the vehicle than the first measuring device, the influence of the way of detection and transmission of an obstacle parameter may be much more important than in the case of the first measuring device. For example, if the second measuring device transmits a GNSS-based message, its accuracy may depend on the environment of the second measuring device, since GNSS does not provide a signal in a tunnel, for example.

The specification of the plurality of second obstacle parameter may include information about the characteristics/properties/quality of second obstacle parameters including the characteristics/properties/quality of the second measuring device. The specification may comprise, for example information about a sensor type of the second measuring device; a message type, a signal resolution and a time stamp of a second measuring parameter and any other information delivering information about the characteristics/properties/quality of the plurality of second obstacle parameters.

In one example, the control device may comprise a specification acquisition unit for acquiring the specification of the plurality of second obstacle parameters before they are sent to the obstacle parameter calculating unit. In this case, the specification acquisition unit may process the signals received from the second measuring device/second obstacle parameter acquisition unit to prepare them for the calculation carried out by the obstacle parameter calculating unit. However, it may be also possible that the obstacle parameter calculating unit directly receives the second obstacle parameter's specification.

According to an example, the specification of the plurality of second obstacle parameters may include a plurality of specification parameters, and the obstacle parameter calculating unit may adjust the value of the confidence indicator based on a value of each specification parameter. In particular, the plurality of specification parameters may include a plurality of information about the boundary conditions under which the plurality of second obstacle parameters are determined. Based on this information, the obstacle parameter calculating unit may increment or decrement the value of the confidence indicator.

In one example, the obstacle parameter calculating unit and/or the specification acquisition unit may receive a time stamp as specification parameter from the second measuring device (or from the second obstacle parameter acquisition unit), which provides the latest time at which the second measuring device has determined the second obstacle parameters. The obstacle parameter calculating unit may then calculate a delay time of the received second obstacle parameters and may decrease/decrement the value of the confidence indicator depending on the length of the delay time. In particular, a long delay time may result in a larger decrease in the confidence indicators' value than a short delay time. In a case that the delay time is shorter than a predetermined threshold value, the confidence level may remain constant. The predetermined threshold value for the delay time may, for example, correspond to the delay time of the first measuring device.

In another example, the obstacle parameter calculating unit and/or the specification acquisition unit may acquire a number of times the second measuring device (or from the second obstacle parameter acquisition unit) has determined the second obstacle parameters (observation length) as specification parameter, and the obstacle parameter calculating unit may decrease/decrement the value of the confidence indicator depending on the observation length. In particular, a short observation length may lead to a larger decrease in the confidence indicators' value than a long observation time. In a case, in which the observation length exceeds a predetermined threshold value, the confidence level may remain constant.

In one more example, the obstacle parameter calculating unit and/or the specification acquisition unit may receive a variance of a determined second obstacle parameter as specification parameter, for example, the variance of the determined velocity signal of the obstacle. In this case, the obstacle parameter calculating unit may decrease/decrement the value of the confidence indicator depending on the variance of the determined parameter, wherein a small variance may result in a smaller decrease in the confidence indicators' value than a large variance. However, if the parameter's variance is below a predetermined threshold value, the confidence level may remain constant.

In one more example, the obstacle parameter calculating unit and/or the specification acquisition unit may receive a message type of a second obstacle parameter as specification parameter. Possible message categories may be, for example, cooperative awareness messages, which provide own information from another car, messages from a road side unit, collective perception messages, which provide information about other objects from another car, messages provided by a mobile device, and other messages not falling in one of the previous categories. In this case, the obstacle parameter calculation unit may increase the value of confidence indicator according to the order of the above message categories, with a cooperative awareness message providing the highest confidence increase, while a message that does not fall into the above categories providing the lowest confidence increase.

In one more example, the obstacle parameter calculation unit and/or the specification acquisition unit may acquire a stability of its communication with the second measuring device as specification parameter, and may adjust the confidence indicator's value based on the communication stability. In this case, the obstacle parameter calculation unit may, for example, determine a signal strength of a wireless communication around the vehicle and derive the communication stability with the second measurement unit from the signal strength. In particular, a high signal strength may indicate stable communication and a low signal strength may indicate unstable communication.

In one more example, in which another vehicle that is the obstacle also serves as second measuring device, the obstacle parameter calculating unit and/or the specification acquisition unit may receive an activation status of the other vehicle's driver assistance system as specification parameter, and may increase/increment the value of the confidence indicator if the driver assistance system is active.

Each of the above-described specification parameter may contribute to the adjustment of the confidence indicator, i.e. the value of the confidence indicator may be the result of a combination of adjustments from the plurality of specification parameters. In this context, it may also be possible that each or at least some of the specification parameters are weighted in view of their importance for a reliable calculation of the third obstacle parameters. In particular, specification parameters with a high importance for an accurate calculation of the plurality of third obstacle parameters may be weighted with a high factor while specification parameters with a low importance for an accurate calculation of the plurality of third obstacle parameters may be weighted with a low factor.

According to another example, the obstacle parameter calculating unit or the specification acquisition unit may receive a plurality of map information of the area surrounding the vehicle, and may adjust the value of the confidence indicator based on the plurality of map information. The map information may be stored in a storage unit of the control device, and may include, for example, information about building locations and traffic congestions based on which the obstacle parameter calculating unit may conclude on the quality of the second obstacle parameters determined by the second measuring device. In particular, the assessment of a message type may be changed based on the map information. For example, the obstacle parameter calculation unit may decrease the increase in the value of the confidence indicator based on a message from a road side unit when traffic congestion occurs directly adjacent thereto, which may cause the obstacle to be obscured by other vehicles.

In the case that the obstacle parameter calculating unit and/or the specification acquisition unit receives map information as described above, it may additionally or alternatively determine the stability of its communication with the second measuring device from the information provided in the map information. For example, if the vehicle is driving through an area with high buildings, communication stability may be low because the buildings may interfere with communication with the second measuring device. The same applies if the vehicle is driving in a busy area where data traffic can be very high. These environmental conditions, which can be derived from the map information, can be used for determining the communication stability between the obstacle parameter calculating unit and/or specification acquisition unit (or in general the control device) and the second measuring device, and the obstacle parameter calculating unit can increase or decrease the value of the confidence indicator based on the respective conditions.

According to an example, the second obstacle parameter acquisition unit may receive the plurality of second obstacle parameters from more than one second measuring devices. In this case the obstacle parameter calculating unit may select the plurality of second obstacle parameters received from the more than one second measuring devices based on at least one of the plurality of specification parameters and at least one of the plurality of map information. For example, the obstacle parameter calculation unit may determine an order of the second measuring devices depending on a message type of their second obstacle parameters. If the message received from a second measuring device is a cooperate awareness message providing information about another vehicle being the obstacle, the other vehicle may be selected as preferable second measuring device as a cooperative awareness message is a highly reliable message. However, the environment of the other vehicle may be also considered when selecting the plurality of second obstacle parameters received from the more than one second measuring devices. If the other vehicle, selected as preferable second measuring device is travelling in a crowded area, the transmission of the communication path to the obstacle parameter calculation unit may be disturbed. Therefore, the obstacle parameter calculation unit may also consider map information when determining the order of second measuring devices.

After selecting the plurality of second obstacle parameters received from the more than one second measuring devices, the obstacle parameter calculating unit may determine if an obstacle detected by one second measuring device is identical to an obstacle detected by another second measuring device based on at least one of the plurality of second obstacle parameters of the one and the other second measuring device.

For example, the obstacle parameter calculating unit may first determine whether the plurality of second obstacle parameters from the one and the other second measuring device include the same obstacle type, for example, whether both second measuring devices have detected a bicycle. If this is the case, the obstacle parameter calculating unit may calculate a distance between an obstacle position included in the second obstacle parameters of the one second measuring device and an obstacle position included in the second obstacle parameters of the other second obstacle device. If the calculated distance is below a predetermined distance threshold, the obstacle parameter calculating unit may identify the obstacle detected by both second measuring devices to be the same object. In this case, the second obstacle parameter acquisition unit may receive the plurality of second obstacle parameters from at least one of the second measuring devices.

However, if the determination is negative, the second obstacle parameter acquisition unit may receive the plurality of the second obstacle parameters from that one of the second measuring devices detecting an obstacle being identical to an obstacle detected by the first measuring device.

According to an example, the obstacle parameter calculating unit may increase the value of the confidence indicator if the obstacles detected by the one and the other second measuring devices are identical, and may decrease the value of the confidence indicator if the obstacles detected by the one and the other second measuring devices are different. In the case that both second measuring devices detect the same obstacle, the reliability of the second obstacle parameters is high as they are determined twice. However, in the case that the one and the other second measuring device detect different obstacles, the reliability of the second obstacle parameters is low as it is not clear which of both second measuring devices detects the relevant obstacle.

According to an example, the obstacle parameter calculating unit may receive a field of view of the one and the other second measuring device, and may decrease the value of the confidence indicator if the field of view of the one second measuring device overlaps with the field of view of the other second measuring device. In this case, the overlapping fields of view may lead to contradicting results in terms of an obstacle detected by the one and the other second measuring device. Therefore, the value of the confidence indicator is decreased if the fields of view of both second measuring devices overlap.

According to an example, the enabling unit may comprise a warning enabling unit that may calculate a warning decision parameter based on the plurality of third obstacle parameters, and may enable a warning as driver assistance if the calculated warning decision parameter is lower than a predetermined warning activation threshold. Furthermore, the enabling unit may comprise an intervention enabling unit that may calculate an intervention decision parameter based on the plurality of third obstacle parameters, and may enable an intervention as driver assistance if the calculated intervention decision parameter is lower than a predetermined intervention activation threshold. In particular, the predetermined warning activation threshold may be larger than the predetermined intervention activation threshold. For example, if the warning and/or the intervention decision parameter is a time-to-collision, the warning activation threshold may include a larger time-to-collision value than the intervention activation threshold. Thus, a warning may be activated earlier than an intervention.

In case that the control device may additionally comprise an activation unit, the activation unit may comprise a warning activation unit that may activate a warning based on a decision of the warning enabling unit, and an intervention activation unit configured to activate an intervention based on a decision of the intervention enabling unit.

According to an example, if the confidence indicator is lower than a second predetermined confidence threshold, the obstacle parameter calculating unit may calculate a first plurality of third obstacle parameters and and a second plurality of third obstacle parameters. The second predetermined confidence threshold may be equal to or larger than the first predetermined confidence threshold.

In this case, the first plurality of third obstacle parameters may be calculated based on the plurality of first obstacle parameters and the plurality of second obstacle parameters, and the second plurality of third obstacle parameters may be calculated only based on the plurality of first obstacle parameters. Furthermore, the warning enabling unit may calculate the warning decision parameter based on the first plurality of third obstacle parameters, and the intervention enabling unit may calculate the intervention decision parameter based on the second plurality of third obstacle parameter. In other words, a warning may be enabled based on a combination of position parameters taken from the plurality of first obstacle parameters and movement parameters taken from the plurality of second obstacle parameters even if the confidence indicator is below the second predetermined threshold. However, an intervention in a driver's driving behaviour may be performed in this case only based on the first obstacle parameters, which may preferably be determined by an on-board measuring device of the vehicle. This ensures that in the event of an external measuring device that may not be one hundred percent reliable, the entire control of the driver assistance system may remain with the vehicle.

However, if the confidence indicator is higher than the second predetermined confidence threshold, which means that also the second obstacle parameters determined from an external measuring device are highly reliable, the obstacle parameter calculating unit may calculate only the first plurality of third obstacle parameters, and the warning enabling unit and the intervention enabling unit may calculate the warning decision parameter and the intervention decision parameter, respectively, based on the first plurality of third obstacle parameters.

The disclosed subject matter may further also comprise a control system in which the control device as explained above and the first and/or second measuring devices are included. The disclosed subject matter further also comprises a vehicle which includes the control device as explained above and at least a first measuring device.

The disclosed subject matter also comprises a method for controlling a driver assistance system for a vehicle, wherein a plurality of first obstacle parameters of a detected obstacle include one or more parameters of a first category and one or more parameters of a second category, and a plurality of second obstacle parameters of the detected obstacle include one or more parameters of the first category and one or more parameters of the second category.

Then, the plurality of first and second obstacle parameters is received by an obstacle parameter calculating unit, and a plurality of third obstacle parameters of the detected obstacle are calculated by the obstacle parameter calculating unit, wherein the plurality of third obstacle parameters include one or more parameters of the first category and one or more parameters of the second category based on the plurality of first and second obstacle parameters, and wherein the one or more parameters of the first category are calculated based the plurality of first obstacle parameters and the one or more parameter of the second category are calculated based on the plurality of second obstacle parameters.

Next, a decision parameter based on the plurality of third obstacle parameters received from the obstacle parameter calculating unit is calculated by an enabling unit, and a driver assistance is enabled if the decision parameter is lower than a predetermined threshold by the enabling unit.

Furthermore, each configuration of the disclosed control device or the control system described above shall also be encompassed by way of a method, which may be claimed by itself and/or by way of a computer program product claim.

In the following the disclosed subject matter will be further explained based on a plurality of examples with reference to the attached drawings. The same elements are provided with the same reference signs and it is refrained from a redundant description of same elements. It is noted again that the Figures show examples which may be varied in accordance with the above-described examples and their further variations and/or in accordance with variations described in connection with the detailed description of the Figures. In particular, this holds for providing, separately or integrated, the first/second measuring device and/or the first/second obstacle parameter acquisition device and the respective adaptions to the data transmission/receiving inputs and outputs. In other words, if the measuring devices and the obstacle parameter acquisition units are provided as separate units, it is a preferred option to transmit information/data about a detected obstacle to the respective obstacle parameter acquisition unit. Said data may already include or be the parameters needed for the further processing and, then, the obstacle parameter acquisition unit mainly functions as input unit of the control device and passes said data (or modified data) to the next unit, such as the obstacle parameter calculation unit. Said data may also include raw detection data/information about a detected object and, then, the obstacle parameter acquisition unit is configured to extract, select and/or determine the relevant parameters and respective data and to send it to the next unit, such as the obstacle parameter calculation unit. Of course, combined options are possible, too. Otherwise, if the measuring devices and the respective obstacle parameter acquisition devices are integrated in a combined or single unit, they may also perform the above explained functions together. Preferably, in case of a combination, only the first measuring device and the first obstacle parameter acquisition unit are combined while the second measuring device (being outside of the vehicle in a preferred example) is provided separate to the second obstacle parameter acquisition unit. As one can see from the following description of the Figures and the Figures themselves, mainly the case of all the four units being separately provided will be shown in the following, which shall however not restrict the present disclosure and the further options and variations as explained, e.g., above.

### BRIEF DESCRIPTION OF DRAWINGS

FIG. 1 schematically shows a control device according to an example of the disclosed subject matter;

FIG. 2 shows a flow chart describing an example of an initializing procedure of the control device depicted in FIG. 1;

FIGS. 3A-B schematically show examples of a plurality of first, second and third obstacle parameters which may be determined by the control device depicted in FIG. 1

FIG. 4A schematically shows an example for tracking an obstacle using a control device other than the one depicted in FIG. 1; and

FIG. 4B schematically shows an example for tracking an obstacle using the control device depicted in FIG. 1;

FIG. 5 shows a flow chart describing an example of identifying that a first measuring unit has detected the same obstacle as a second measuring unit by the control device depicted in FIG. 1;

FIG. 6 shows a flow chart describing an example of enabling a driver assistance by the control device depicted in FIG. 1;

FIG. 7A schematically shows an example of activating a driver assistance using a control device other than the one depicted in FIG. 1; and

FIG. 7B schematically shows an example of activating a driver assistance using the control depicted in FIG. 1;

FIG. 8 schematically shows a control device according to another example of the disclosed subject matter;

FIGS. 9A-B each show a flow chart describing an example of receiving a specification of a plurality of second obstacle parameters and adjusting a confidence indicator of the second obstacle parameters based on the received specification by the control device depicted in FIG. 8;

FIGS. 10A-B each show a flow chart describing an example of adjusting the confidence indicator based on a specification parameter by the control device depicted in FIG. 8;

FIGS. 11A-B each show a flow chart describing an example of adjusting the confidence indicator based on another specification parameter by the control device depicted in FIG. 8;

FIG. 12 shows a flow chart describing an example of adjusting the confidence indicator based one more specification parameter by the control device depicted in FIG. 8;

FIG. 13 shows a flow chart describing an example of adjusting the confidence indicator based on map information by the control device depicted in FIG. 8;

FIG. 14 shows a flow chart describing an example of adjusting the confidence indicator based one more specification parameter by the control device depicted in FIG. 8;

FIGS. 15A-B each show a flow chart describing an example of processing a plurality of second obstacle parameters received from more than one second measuring device by the control device depicted in FIG. 8;

FIG. 16 shows a flow chart describing an example of prioritizing the plurality of second obstacle parameters received from more than one second measuring device by the control device depicted in FIG. 8;

FIGS. 17A-C each show a flow chart describing an example of identifying the plurality of second obstacle parameters received from more than one second measuring device by the control device depicted in FIG. 8;

FIGS. 18A-B schematically show an example of a driver assistance when an obstacle is detected by a second measuring device using the control device depicted in FIG. 8;

FIGS. 19A-B schematically show an example of a driver assistance when an obstacle is detected by more than one second measuring device using the control device depicted in FIG. 8;

FIGS. 20A-C each show a flow chart describing an example of adjusting the confidence indicator based on different fields of view of more than one second measuring device by the control device depicted in FIG. 8;

FIG. 21 schematically shows a control device according to one more example of the disclosed subject matter;

FIG. 22 shows a flow chart describing an example of receiving a specification of a plurality of second obstacle parameters and adjusting a confidence indicator of the second obstacle parameters based on the received specification by the control device depicted in FIG. 21;

FIGS. 23A-B show a flow chart describing an example of an initializing process of the control device depicted in FIG. 21;

FIG. 24 shows a flow chart describing an example of enabling a driver assistance by the control device depicted in FIG. 21;

FIGS. 25A-B schematically show an example of a driver assistance performed using a control device other than the one depicted in FIG. 21 compared with a driver assistance performed using the control device depicted in FIG. 21;

FIG. 26 schematically shows a result of the driver assistance examples depicted in FIGS. 25A-B;

FIG. 27 schematically shows a control device according to one more example of the disclosed subject matter;

FIG. 28 schematically shows an example of a driver assistance when an obstacle is detected using the control device depicted in FIG. 27; and

FIGS. 29A-B schematically show another example of a driver assistance when an obstacle is detected using the control device depicted in FIG. 27;

FIG. 30 schematically shows a control device according to one more example of the disclosed subject matter;

FIG. 31 shows a flowchart describing an example of a control process carried out by the control device shown in FIG. 30; and

FIGS. 32A-B schematically show an example of driver assistance performed using a control device other than the one depicted in FIG. 30 compared to an example of driver assistance performed using the control device depicted in FIG. 30.

### DESCRIPTION OF EMBODIMENTS

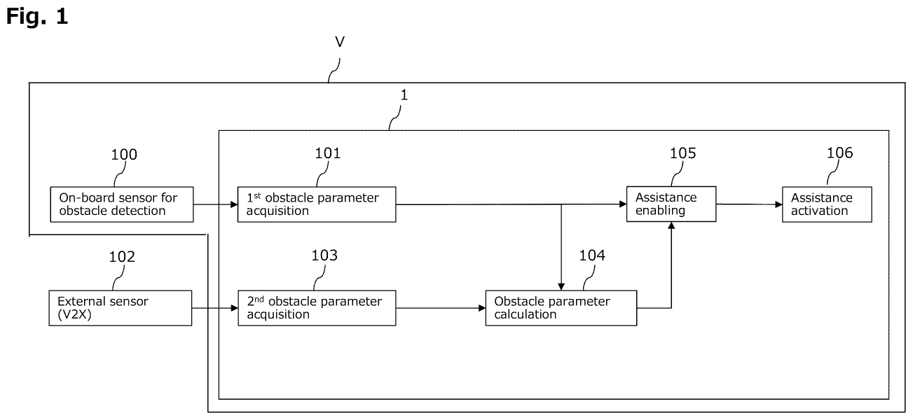

FIG. 1 schematically shows a control device 1 according to an example of the disclosed subject matter. The control device 1 is mounted to a vehicle V and the vehicle V comprises an on-board sensor (first measuring device) 100 for detecting an obstacle in the surroundings of the vehicle V; the first measuring device/on-board sensor 100 may for example include a radar sensor, a camera sensor, a lidar sensor, a sonar sensor, a GNSS sensor and/or any other sensor suitable to detect an obstacle in the surroundings of a vehicle V. In addition, the control device 1 is communicably connected with an external sensor (second measuring device) 102 that may be connected to the control device 1 via vehicle-to-location (V2X) communication. The external sensor 102 may also be a radar sensor, a camera sensor, a lidar sensor, a sonar sensor, a GNSS sensor and/or any other sensor suitable to detect an obstacle in the surroundings of the vehicle V, wherein the external sensor 102 may be included, for example, in another vehicle, a road side unit and/or a mobile device. A communication between the on-board sensor 100 and the control device 1 may be executed in real time, while a communication between the external sensor 102 and the control device 1 may be executed, for example, via a cellular network, which is accompanied by a longer latency period.

The on-board sensor 100 and the external sensor 102 both may detect an obstacle in the area surrounding the vehicle V and may determine a plurality of first and second obstacle parameters including, for example, obstacle type, position, heading, velocity, yaw rate and acceleration of the detected obstacle.

The plurality of first and second obstacle parameters may be divided into a first group including one or more parameters of a first category and a second group including one or more parameters of a second category. The category of a parameter may be defined, for example, by a characteristic/attribute/property that one parameter may have in common with another parameter. In particular, a parameter of the first category may be a position parameter of the obstacle including static information about the obstacle and a parameter of the second category may be a movement parameter of the obstacle including dynamic information about the obstacle.

Static information about the obstacle may be, for example, the type of obstacle (pedestrian, bicycle, vehicle, etc.), the current time at which the obstacle is detected (time stamp), and its current position and heading. In particular, a static information is characterized by the fact that it is not time-dependent at the time of acquisition. On the contrary, dynamic information about the obstacle may be, for example, its velocity, yaw rate and acceleration. In particular, a dynamic information is characterized by the fact that it is time-dependent at the time of acquisition.

Further, the control device 1 according to the depicted example comprises a first and second obstacle (parameter) acquisition unit 101, 103, which may receive the plurality of first and second obstacle parameters from the on-board sensor 100 and the external sensor 102. The obstacle parameter acquisition units 101, 103 may, for example, perform processing of the first and second obstacle parameters (e.g., smoothing, filtering, averaging) before they are transmitted to an obstacle parameter calculation unit 104 of the control device 1 or they may determine or select the parameters especially when the first/second measuring devices are mainly configured to detect objects. Further, it may also be possible that the obstacle parameter calculation unit 104 receives the first and second obstacle parameters directly from the on-board sensor 100 and the external sensor 102.

FIG. 1 shows a configuration in which the control device 1 is part of the vehicle V while the external sensor (second measuring device) 102 is arranged remotely to the vehicle V. However, in an alternative variation, both measuring devices 100 and 102 may be arranged outside/remotely to the vehicle V. Additionally or alternatively, the example of FIG. 1 (or the further control devices 1a-1d) may also be varied in such way that at least one of the sensors (first/second measuring devices) may be combined with a respective obstacle parameter acquisition unit 101, 103. For example, in another variation, the first measuring device 100 and the first obstacle parameter acquisition unit 101 may be the same or an integrated unit (instead of being separate units) and more preferably, then, they both may be part of the control device 1. In this same variation, the second measuring device 102 may be located remotely to the vehicle V so that the second obstacle parameter acquisition unit 103 would be arranged as depicted in FIG. 1.

The obstacle parameter calculating unit 104 then calculates a plurality of third obstacle parameters based on the plurality of first and second obstacle parameters, which may include one or more position parameters and one or more movement parameters. In other words, the obstacle parameter calculating unit 104 uses the plurality of first and second obstacle parameters determined by the on-board sensor 100 and the external sensor 102 (or the obstacle parameter acquisition units) for calculating a new set of third obstacle parameters.

Since a position parameter, such as position and heading of the obstacle may change its value each time it is determined by the first/second measuring devices (sensors) 100, 102, it is preferably transmitted immediately to the obstacle parameter calculation unit 104 so that the latter may obtain a current value of the position parameters. However, a movement parameter, such as velocity, acceleration and yaw rate of the obstacle can be assumed to remain constant within the observed time slot. Therefore, the transmission time of a movement parameter to the obstacle parameter calculation unit 104 may be less important than in the case of the transmission of a position parameter. On the other hand, the accuracy and reliability of the determination of an obstacle parameter increases with every determination (step), i.e., the earlier a constant obstacle parameter can be determined, the higher its accuracy and reliability.

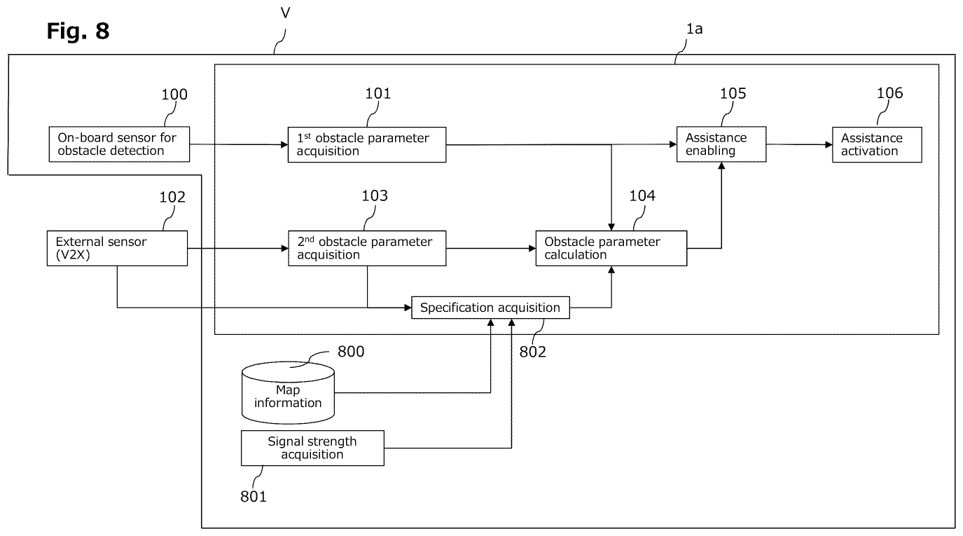

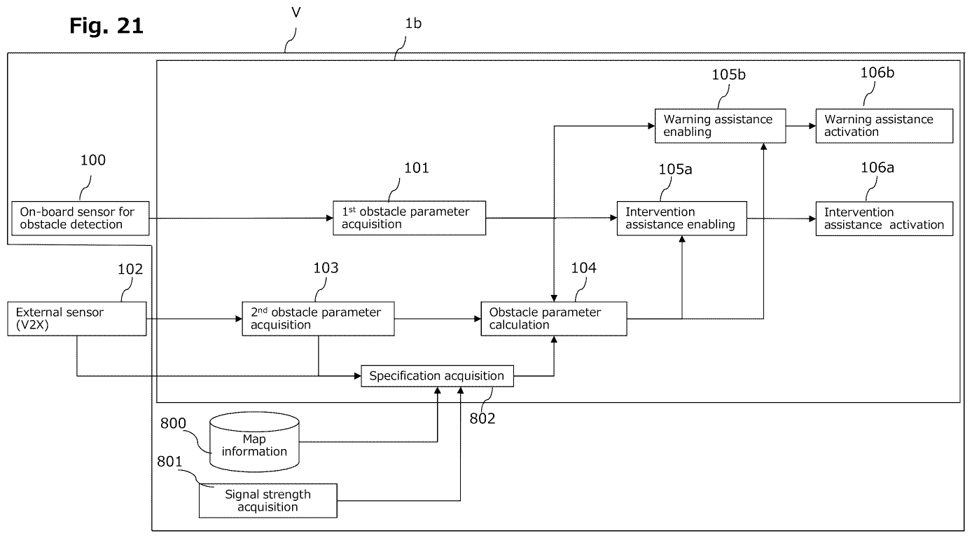

As noted above, the parameters of the obstacle(s) may also be determined by the obstacle parameter acquisition units from the detected object data received from the sensors 100, 102. In the following, for the sake of simplification, the example is described in which the sensors 100, 102 determine the parameters of the detected obstacle(s) and transmit them, preferably via the first/second obstacle parameter units 101, 103 even if not explicitly mentioned, to the next unit, such as the obstacle parameter calculation unit 104 of the control device 1. This holds also for the further variations of the control devices, such as shown in FIG. 8, FIG. 21, and the like.

Hence, the obstacle parameter calculating unit 104 preferably reads the position parameters, which can be determined more reliably by the on-board sensor 100, from the plurality of first obstacle parameters, and the movement parameters, which can be determined more reliably by the external device 102, from the plurality of second obstacle parameters for calculating the new set of third obstacle parameters.

The depicted control device 1 further includes an enabling unit 105 that calculates a first decision parameter based on the plurality of third obstacle parameters received from the obstacle parameter calculating unit 104, and enables a driver assistance if the decision parameter is lower than a predetermined activation threshold. In other words, the obstacle parameter calculation unit 104 sends the plurality of third obstacle parameters to the enabling unit 105, which derives a comparison figure (decision parameter) from the third obstacle parameters to decide whether to activate a driver assistance. A driver assistance may be, for example, an automatic braking, accelerating or steering. Alternatively or additionally, a driver assistance can also be an acoustic or visual signal that prompts the driver to perform a certain action.

The enabling unit 105 then compares the decision parameter with a predetermined activation threshold and enables a driver assistance if the decision parameter falls below the threshold. For example, the enabling unit 105 may calculate a time until the vehicle reaches the obstacle (time-to-collision) or a difference between the vehicle and the obstacle as decision parameter based on the third obstacle parameters. The predetermined activation threshold in this case may be a predetermined time or a predetermined distance.

In the depicted example, the control device 1 may additionally comprise an activation unit 106, which may activate the driver assistance based on an enabling signal received from the enabling unit. In this case, the enabling unit 105 can send an enabling signal to the activation unit 106, which then activates actuators/control elements for driver assistance in the vehicle, such as hydraulic valves for braking or steering actuation and/or signal outputs for providing acoustic or visual information. However, it may also be possible that the respective actuators are directly activated by (signals sent by) the enabling unit 105 As the enabling unit 105 derives the first decision parameter from the plurality of third obstacle parameters being based on the most reliable obstacle parameters received from the on-board sensor 100 and the external sensor 102, the enabling unit 105 can determine the first decision parameter with high accuracy at an early time. This allows the control device to activate a driver assistance before an obstacle appears in the immediate vicinity of the vehicle, thus avoiding an abrupt driving operation and increasing driving comfort.

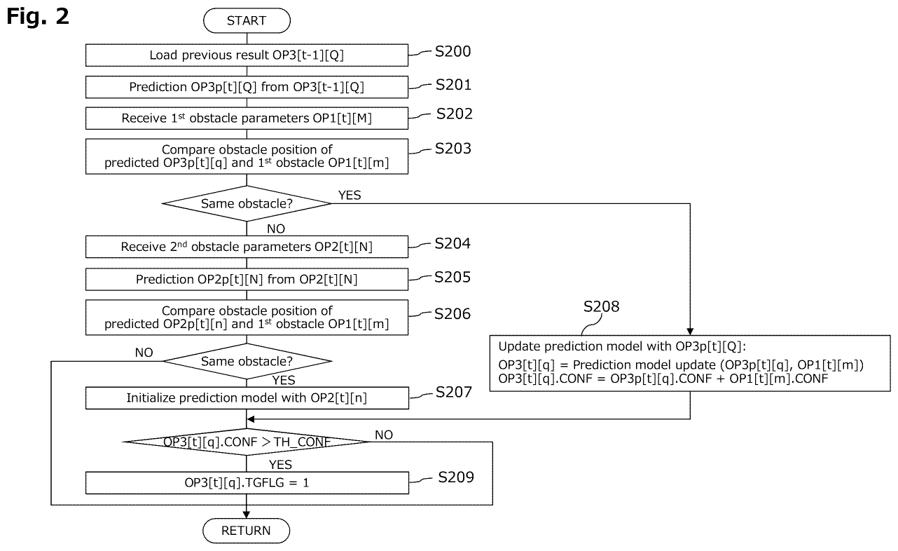

FIG. 2 shows a flow chart describing an example of an initializing procedure of the control device 1 depicted in FIG. 1. In particular FIG. 2 shows an initializing process of a prediction model included in the obstacle parameter calculation unit 104 of the control device 1 depicted in FIG. 1.

For verifying whether an initializing of the prediction model is needed, a previously calculated plurality/set of third obstacle parameters OP3[t−1][Q] is loaded by the obstacle parameter calculation unit 104 in step S200, wherein the variable Q indicates a matrix of third obstacle parameters and the variable t indicates a time.

In the subsequent step S201, the prediction model of the obstacle parameter calculation unit 104 calculates a present set of third obstacles parameters OP3p[t][Q] based on the third obstacle parameters OP3[t−1][Q] determined in the previous step. Then, in step S202, the obstacle parameter calculation unit 104 receives a current set of first obstacle parameters OP1[t][M], wherein the variable M indicates a matrix of first obstacle parameters.

Next, in step S203, the obstacle parameter calculation unit 104 compares an obstacle position from the present set of third obstacle parameters OP3p[t][Q] with an obstacle position from the set of first obstacle parameters OP1[t][M].

If both positions are identical, the prediction model of the obstacle parameter calculation unit 104 is updated in step S208 with the calculated current set of third obstacle parameters OP3p[t][Q] and the position parameters OP1[t][m] of the plurality of first obstacle parameters.

Additionally, in step S208, a confidence indicator of the third obstacle parameters OP3[t][q].CONF is incremented as the obstacle parameter calculation unit 104 has received a new set of first obstacle parameters from the on-board sensor 100. Each received set of first obstacle parameters from the on-board sensor 100 increases the reliability of the obstacle detection, therefore the confidence indicator OP3[t][q].CONF is incremented each time the obstacle parameter calculation unit 104 receives new first obstacle parameters from the on-board sensor 100.

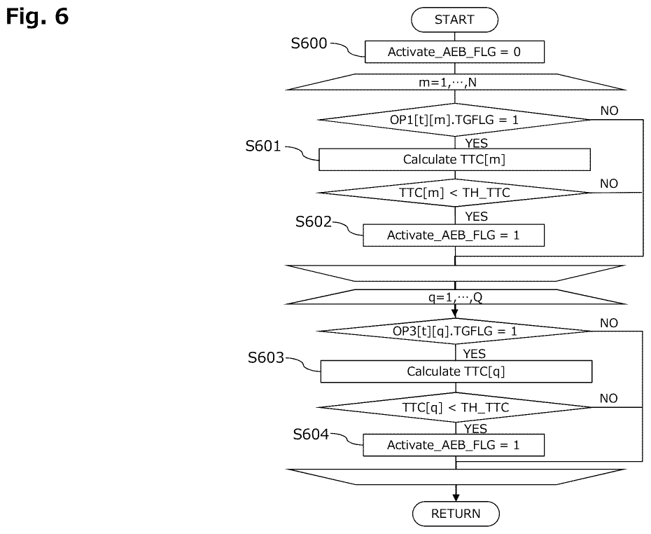

Then, it is verified if the confidence indicator OP3[t][q].CONF is higher than a first predetermined confidence threshold TH_CONF, and if this is the case, a confidence flag of the third obstacle parameters OP3[t][q].TGFLG is set to 1 in step S209, to indicate that the plurality of third obstacle parameters can be used by the enabling unit 105 for determining a time-to-collision TTC[Q] as decision parameter (see FIG. 6).

However, if the position parameters of the first and third obstacle parameters are not identical, the obstacle parameter calculation unit 104 receives the plurality of second obstacle parameters OP2[t][N] determined by the external sensor 102 in step S204, wherein the variable N indicates a matrix of second obstacle parameters. In the next step S205, the prediction model of the obstacle parameter calculation unit 104 calculates a present set of second obstacles parameters OP2p[t][N] based on the determined second obstacle parameters OP2[t][N], as the communication between the external sensor 102 and the obstacle parameter calculation unit 104 involves a delay.

Next, the obstacle parameter calculation unit 104 compares a position of an obstacle from the present set of second obstacle parameters OP2p[t][N] with a position of an obstacle from the set of first obstacle parameters OP1[t][M] in step S206.

If both positions are identical, in step S207, the prediction model of the obstacle parameter calculation unit 104 is initialized with the movement parameters OP2p[t][n] of the current second obstacle parameters OP2p[t][N] and the position parameters OP1[t][m] of the first obstacle parameters.

Afterwards, the process continues as described above by verifying whether the confidence indicator OP3[t][q].CONF is higher than the predetermined confidence threshold TH_CONF. If so, the confidence flag of the third obstacle parameters OP3[t][q].TGFLG is set to 1 in step S209 to indicate that the plurality of third obstacle parameters can be used by the enabling unit 105 to determine a time to collision TTC[Q] as a decision parameter (see FIG. 6).

If the positions of the obstacle in the first and second obstacle parameters are not identical, the obstacle parameter calculation unit 104 considers the obstacle detected by the on-board sensor 100 to be a new or other obstacle in the first obstacle parameters. In this case, the described process is repeated until the external sensor 102 has also detected the new obstacle in the second obstacle parameters.

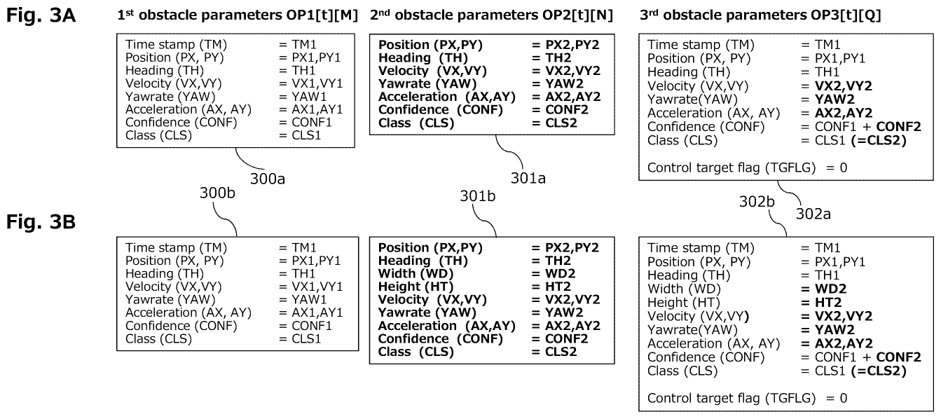

FIG. 3A and FIG. 3B schematically show examples of a plurality of first, second and third obstacle parameters which may be determined by the control device depicted in FIG. 1.

In particular, FIG. 3A shows a plurality of first obstacle parameters OP1[t][M] determined by a first measuring device, such as the on-board sensor 100 depicted in FIG. 1 The plurality of first obstacle parameters OP1[t][M] includes a position in x- and y-coordinates PX1, PY1 of the obstacle detected by the first measuring device 100 as well as a heading TH1, a velocity in x- and y-direction VX1, VY1, a yaw rate YAW1, an acceleration in x- and y-direction AX1, AY1 of the detected obstacle. Additionally, the depicted plurality of first obstacle parameters OP1[t][M] comprises a confidence indicator CONF1, expressing a reliability of the determined first obstacle parameters OP1[t][M], and a type/class CLS1 of the detected obstacle, wherein class might indicate the type of a vehicle or of an obstacle or another traffic participant, such as car, bicycle, fixed obstacles, pedestrians, and the like.

FIG. 3A also shows a plurality of second obstacle parameters OP2[t][N], which comprise the same types of parameters as the plurality of first obstacle parameters OP1[t][M]. The second obstacle parameters are determined by a second measuring device, such as the external sensor 102 shown in FIG. 1, and they are indicated by a “2” accordingly.

The first obstacle parameters are shown in normal font while the second obstacle parameters are marked by bold signs (letters, numbers, etc.). In this way it is highlighted which parameters of the third obstacle parameters have been taken from the first obstacle parameters and which have been taken from the second obstacle parameters, to determine initial values for the prediction model of the obstacle parameter calculation unit 104.

In other words, FIG. 3A shows the values of the third obstacle parameters in bold if they have been taken from/if they are values of the second obstacle parameters while the not bold values of the third obstacle parameters have been taken from/are values of the first obstacle parameters.

The third obstacle parameters OP3[t][Q] are shown on the right side of FIG. 3A, where the position parameters timestamp TM1, position PX1, PY1, and heading TH1 are marked not bold, i.e. they have been taken from the first obstacle parameters, while the movement parameters velocity VX2, VY2, yaw rate YAW2, and acceleration AX2, AY2 are marked bold, i.e. they have been taken from the second obstacle parameters.

The depicted third obstacle parameters OP3[t][Q] further include a confidence indicator preferably composed of the confidence indicators CONF1 and CONF2 of the first and second obstacle parameters (here, e.g., they are added as indicated by “+”), and a type/class of the detected vehicle identical to that of the first and second obstacle parameters CLS1 and CLS2. Furthermore, the third obstacle parameters contain the confidence flag TGFLG, which is preferably set to 0 at a first time an obstacle is detected by the first and second measuring device 100, 102.

In FIG. 3B a case is shown where the obstacle is another vehicle which also serves as second measuring device 102. In this case the second obstacle parameters OP2[t][N] also include a width WD2 and a high HT2 of the vehicle, which are in taken over in the third obstacle parameters to initialize the prediction model of the obstacle parameter calculation unit 104.

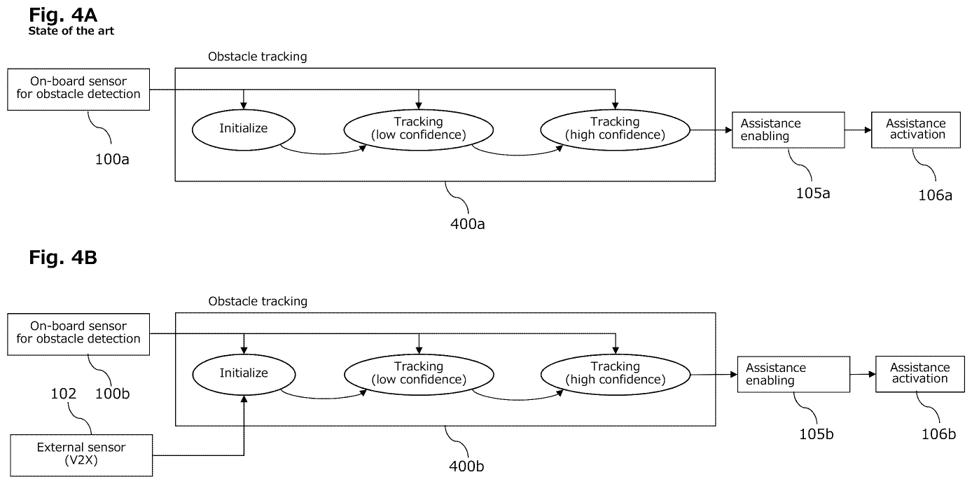

FIG. 4A schematically shows an example for tracking an obstacle using a control device other than the one depicted in FIG. 1, and FIG. 4B schematically shows an example for tracking an obstacle using the control device depicted in FIG. 1.

In the example shown in FIG. 4A, only an on-board sensor 100a is used to detect an obstacle. In this case, when the obstacle is detected, an obstacle tracking unit 400a is initialized using only the first obstacle parameters determined by the on-board sensor 100a. Further, tracking of the obstacle is also performed based only on the first obstacle parameters determined by the on-board sensor 100a. Depending on the number of times the obstacle parameters are determined by the on-board sensor 100a, the confidence in the determined parameters increases. If this confidence exceeds a predetermined threshold, a change from a low to a high confidence (value) of the determined parameters is performed by the obstacle tracking unit 400a. Thereafter, a time to collision or so can be calculated by an enabling unit 105a, whereupon a driver assistance can be activated by an activation unit 106a if the time to collision is less than a predetermined threshold.

An example of the herein disclosed teaching is then depicted in the example as shown in FIG. 4B. In this example the control device of FIG. 1 is employed, an additional external sensor 102 is applied in addition to the on-board sensor 100b which is able to detect an obstacle earlier than the on-board sensor 100b but which may have a longer/slower communication path/speed to an obstacle tracking unit 400b. In this case, the obstacle tracking unit 400b, which may include at least the obstacle parameter calculation unit 104 of the control device shown in FIG. 1, is initialized with position parameters taken from first obstacle parameters determined by the on-board sensor 100b and movement parameters taken from second obstacle parameters determined by the external sensor 102. As the obstacle parameters having the highest initial confidence can be taken/selected from the two sensors 100b, 102, the confidence (value) of the determined parameters converges/increases faster than in the example shown in FIG. 4A. As a result, a time-to-collision can be calculated earlier by the enabling unit 105b resulting in an earlier activation of a driver assistance by the activation unit 106b.

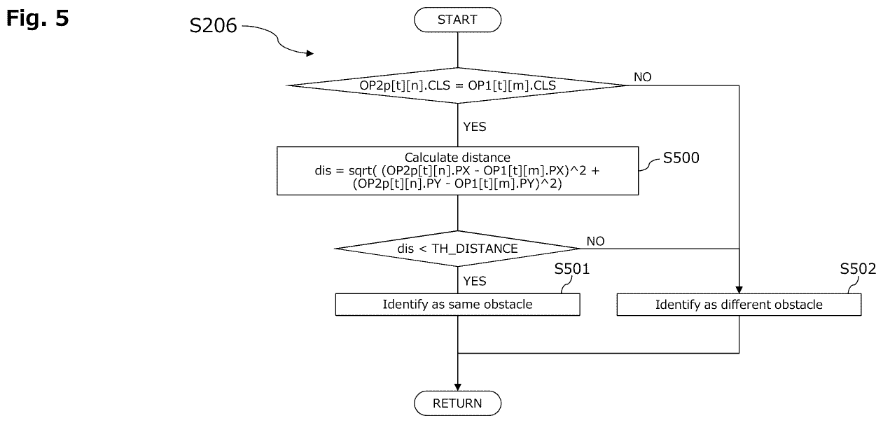

FIG. 5 shows a flow chart of a sub-routine of the control device of FIG. 1 which describes an example of identifying whether a first measuring unit has detected the same obstacle like a second measuring unit. In particular, the process as shown by the flow chart of FIG. 5 shows an example according to which the evaluation of whether a same obstacle has been detected is performed by comparing the positions of the obstacle of the first and the second obstacle parameters according to step S206 of FIG. 2.

After the start of the process of FIG. 5, the obstacle parameter calculation unit 104 firstly checks (first decision step in FIG. 5) whether the first and second measuring devices have detected an obstacle of the same type/class, wherein, in FIG. 5, the term CLS refers to a type/class of an obstacle, and the variables n and m indicate the second and first obstacle parameter, respectively. Then, in step S500 the obstacle parameter calculation unit 104 calculates a distance dis between the positions of the obstacles detected by the first and second measuring devices using a least square method (sqrt—square root), wherein the terms PX and PY refer to x- and y coordinates of the obstacles' position. If the distance dis is smaller than a predetermined distance threshold TH_DISTANCE, the detected obstacles are identified as the same obstacle in step S501, and the process illustrated in the flow chart of FIG. 2 continuous with step S206. However, if the distance dis is larger than the predetermined distance threshold TH_DISTANCE, two different obstacles are identified in step S502, and the process shown in the flowchart of FIG. 2 returns to step S204. The latter also applies if the obstacle parameter calculation unit 104 has determined a different type of an obstacle at the start of the process (“no”-path from the first decision step in FIG. 5).

FIG. 6 shows a flow chart describing an example of enabling/activating a driver assistance by the control device depicted in FIG. 1.

In the first step S600, an activation flag AEB_FLG of a driver assistance, which in the present example comprises an automatic emergency brake (AEB), is set to 0, i.e. the automatic emergency brake is deactivated.

In the following calculation loop, the enabling unit 105 of the control device shown in FIG. 1 checks whether the confidence flag TGFLG=1 is set for each of the plurality of first obstacle parameters m=1, . . . , N, and calculates a time-to-collision TTC[m] based on each of the plurality of first obstacle parameters m=1, . . . , N if the result is positive (S601). In case the determined time-to-collision TTC [m] is smaller than a predetermined activation threshold TH_TTC, the enabling unit activates an automatic emergency braking by setting the activation flag AEB_FLG to 1 in step S602. In case that any of the above described checks is negative, the process leaves the current calculation loop and proceeds further to a second calculation loop in which the time to collision TTC[q] is calculated based on the plurality of third obstacle parameters q=1, . . . , Q.

In the second calculation loop including the steps S603 and S604. the above described process is carried out for the plurality of third obstacle parameters q=1, . . . , Q. In step S603, a time-to-collision TTC[q] is calculated by the enabling unit 105 based on the plurality of third obstacle parameters q=1, . . . , Q, and in step S604, an automatic emergency braking is activated by the enabling unit (AEB_FLG=1) if the determined time-to-collision TTC [q] is smaller than the predetermined activation threshold TH_TTC. If any of the checks carried out in the second calculation loop is negative, the process returns to step S600 and proceeds further until the activation flag AEB_FLG of the automatic emergency brake is set to 1.

This means that an automatic emergency braking can be activated either by a time-to-collision TTC[m] calculated based on the first obstacle parameters and/or by a time-to-collision TTC[q] calculated based on the third obstacle parameters. The use of both sets of parameters, namely the plurality of first and third obstacle parameters, ensures on the one hand that automatic emergency braking is initiated even if no second measuring device is available. On the other hand, using the third obstacle parameters for calculating the time-to-collision enables an earlier activation of the automatic emergency braking if a second measuring device is available, since the third obstacle parameters enable an earlier setting of the confidence flag TGFLG=1. Thus, it allows for an improved driving comfort while at the same time the reliability of the AEB functions is even further increased.

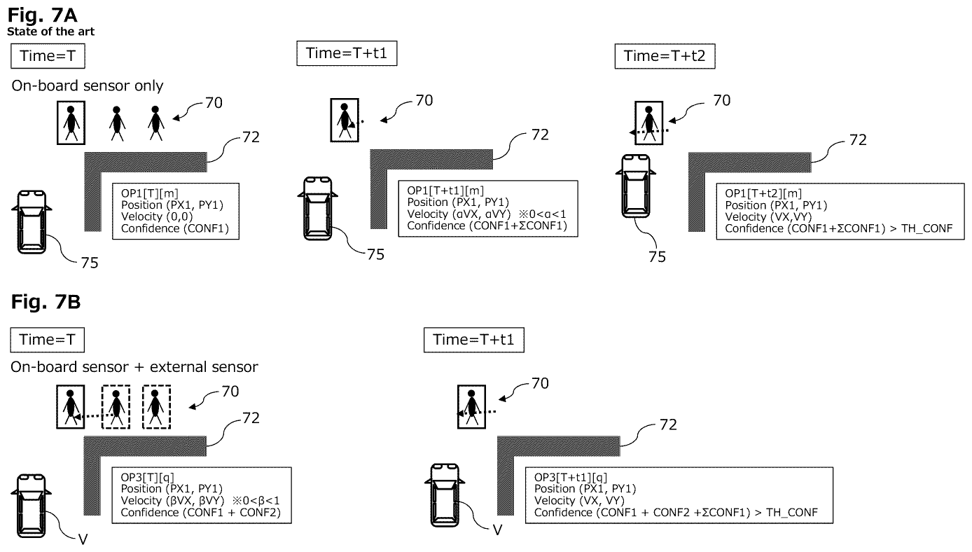

FIG. 7A schematically shows an example of activating a driver assistance using a control device other than the one depicted in FIG. 1, and FIG. 7B schematically shows an example of activating a driver assistance using the control device 1 depicted in FIG. 1.

In particular, FIG. 7A shows an example in which a driving assistance, such as an emergency braking, is enabled only based on a plurality of first obstacle parameters, while FIG. 7B shows an example in which a driver assistance such as an emergency braking is enabled based on a plurality of first and second obstacle parameters.

In both figures, a pedestrian 70, a boundary 72 (such as a wall of a building or the like) and a vehicle 75 or V having an on-board sensor as a first measuring device are depicted. The pedestrian 70 approaches a front of the vehicle 75 or V from an area behind the boundary 72 at a time T.

According to FIG. 7A, the on-board sensor of the vehicle determines first obstacle parameters OP1[T][m] at the time T when it detects the pedestrian 70 for the first time.

The position of the pedestrian at which they is determined for the first time by the on-board sensor is marked by a frame around the pedestrian. The first obstacle parameters OP1[T][m] include x- and y-coordinates of this position PX1, PY1 but they do not include a velocity of the pedestrian 70, since at this time no previous position of the pedestrian is known, based on which the pedestrian's velocity could be determined by the on-board sensor of the vehicle 75. Thus the confidence indicator CONF1 of the first obstacle parameters OP1[T][n] is low at the time T.

At a time T+t1, the on-board sensor of the vehicle 75 has determined the first obstacle parameters OP1[T+t1][n] at least one more time (indicated by a length of the dotted arrow attached to the frame around the pedestrian 70), now including the velocity of the pedestrian 70 in x- and y-direction VX, VY which is afflicted by a factor □ smaller than 1 indicating that a variance of the determined velocity is still high due to a limited number of measuring points. The confidence indicator CONF1 of the first obstacle parameters OP1[T+t1][n] has been increased at the time T+t1 by the number of times □CONF that the on-board sensor of the vehicle 75 has determined the first obstacle parameters of the pedestrian 70.

At a time T+t2, the on board sensor of the vehicle has observed the pedestrian 70 for a longer time (indicated by the increased length of the dotted arrow attached to the frame around the pedestrian 70) so that a velocity VX1, VY1 of the pedestrian can now be determined with suitable accuracy. That is, the confidence indicator of the first obstacle parameters CONF1 has exceeded the first predetermined confidence threshold TM_CONF and a time-to-collision can be reliably calculated based on the first obstacle parameters OP1[T+t2][n] at the time T+t2.

On the contrary, FIG. 7B shows an example in which the plurality of first obstacle parameters is also determined by the on-board sensor 100 of the vehicle V, and additionally a plurality of second obstacle parameters is determined by an external sensor, such as the mobile device of the pedestrian 70. The external sensor can determine second obstacle parameters of the pedestrian 70 before the on-board sensor of the vehicle has detected the pedestrian 70 for the first time at the time T. This is indicated by the dotted frames around the positions of the pedestrian 70 when the pedestrian is still located in an area behind the boundary 72, where the pedestrian is not visible for the on-board sensor of the vehicle V. The position of the pedestrian 70 at which the on-board sensor detects them for the first time is again marked by a solid frame around the pedestrian 70. At this time the pedestrian has been observed by the external sensor for a certain time already, which is indicated by the length of the dotted arrow attached to the solid frame around the pedestrian 70.

In this case, the control device 1 has already calculated a plurality of third obstacle parameters OP3[T][q] at the time T including the position PX1, PY1 of the pedestrian 70a, which has been determined by the on-board sensor, and the velocity VX, VY of the pedestrian 70, which has been determined, e.g., by the pedestrian's mobile device. The velocity is afflicted by a factor □ smaller than 1 indicating that a variance of the determined velocity is still high due to a limited number of measuring points. However, it is possible to provide a velocity of the pedestrian 70 at the first time the latter is recognized by the on-board sensor of the vehicle V. As the third obstacle parameters are calculated based on the position parameters of the first obstacle parameters and the movement parameters of the second obstacle parameters, the confidence indicator considers a confidence CONF1, CONF2 of the first and second obstacle parameters, and is thus higher than the confidence indicator CONF1 at the time T in FIG. 7A.

At a time T+t1, the on-board sensor 100 has determined the first obstacle parameters OP1[T+t1][n] at least one more time, so that the confidence indicator CONF1+CONF2 is increased by the number of times □CONF that the on-board device has determined the first obstacle parameters of the pedestrian 70. The value of the confidence indicator has therefore already exceeded the predetermined threshold TH_CONF at the time T+t1. Consequently, a time-to-collision can be calculated reliably based on the third obstacle parameters OP3[T+t1][n] already at the time T+t1.

FIG. 8 schematically shows a control device 1a according to another example of the disclosed subject matter. In addition to the control device 1 depicted in FIG. 1, the depicted control device 1a comprises a specification acquisition unit 802, which may receive a specification of the plurality of second obstacle parameters from the external sensor (second measuring device) 102 and/or the second obstacle parameter acquisition unit 103. Further, a storage 800 in which map information about the surroundings of the vehicle V are stored, and a signal strength acquisition unit 801, which may acquire a signal strength of a wireless communication around the vehicle V may be provided in the vehicle V (as depicted). It may be possible also that the specification acquisition unit 802, the map information storage 800 and the signal strength acquisition unit 801 are included in the obstacle parameter calculation unit 104 and thus in the control device 1a (not shown). Further, alternatively, the storage 800 and the signal strength acquisition unit 801 may be located remotely to the vehicle V (not shown).

In the example depicted in FIG. 8, the obstacle parameter calculating unit 104 may calculate the confidence indicator considering a specification of the plurality of second obstacle parameters determined by the external sensor (second measuring device) 102. Since the external sensor 102 is located remotely to the vehicle V, the influence of the way of detection and transmission of the second obstacle parameters may be stronger than in the case of the on-board sensor 100. For example, if the external sensor transmits a GNSS-based message, its accuracy may depend on the environment of the external sensor 102, since GNSS may not provide a signal in a tunnel, for example.

Thus, the set/specification of the plurality of second obstacle parameter may include information (specification parameters) about the characteristics/properties/quality of the second obstacle parameters including the characteristics/properties/quality of the external sensor 102. The specification may comprise, for example, information about a sensor type of the external sensor 102, a message type, a signal resolution and a time stamp of a second measuring parameter and/or any other transmission information about the characteristics/properties/quality of the plurality of second obstacle parameters. The specification acquisition unit 802 may receive the specification of the plurality of second obstacle parameters from the external sensor 102 and/or the second obstacle parameter acquisition unit 103 before sending them to the obstacle parameter calculation unit 104 to prepare them for further processing by the latter. The obstacle parameter calculation unit 104 may then adjust a value of the confidence indicator based on the plurality of specification parameters received from the specification acquisition unit 802.

In addition to the specification of the second obstacle parameters, the specification acquisition unit 802 may receive a plurality of map information from the map information storage 801 including, for example, information about building locations and the like as well as traffic information, such as congestions, based on which the obstacle parameter calculating unit 104 may also conclude on the quality of the second obstacle parameters determined by the external sensor 102.

Furthermore, the specification acquisition unit 802 may receive a signal strength of the wireless communication around the vehicle from the signal strength acquisition unit 801 based on which a stability of the communication path between the external sensor 102 and the obstacle parameter calculating unit 104 and/or the specification acquisition unit 802 may be determined.

Additionally or alternatively the obstacle parameter calculation unit 104 and/or the specification acquisition unit 802 may determine the stability of the communication path between the external sensor 102 and the obstacle parameter calculating unit 104 and/or the specification acquisition unit 802 from the information provided in the map information. For example, if the vehicle V is driving through an area with high buildings, communication stability/reliability/quality may be low because the buildings may impede the communication with the external sensor 102. The same applies if the vehicle is driving in a busy area where data traffic can be very high. These environmental conditions, which can be derived from the map information, can be used for determining the communication stability between the obstacle parameter calculating unit 104 and/or the specification acquisition unit 802 and the external sensor 102, and the obstacle parameter calculating unit 104 can increase or decrease the value of the confidence indicator based on the respective conditions.

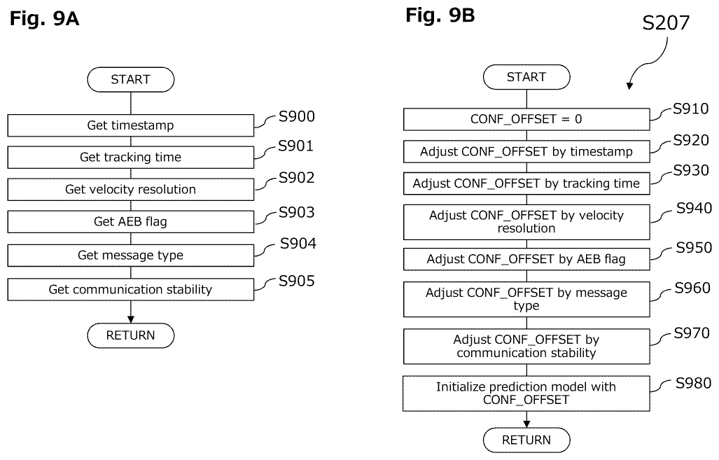

FIG. 9A and FIG. 9B each show a flow chart describing an example of receiving a specification of a plurality of second obstacle parameters and of adjusting a confidence indicator of the second obstacle parameters based on the received specification by the control device 1a depicted in FIG. 8.

In particular, FIG. 9A shows a plurality of specification parameters received by the obstacle parameter calculation unit 104 and/or the specification acquisition unit 802 of the control device shown in FIG. 8. In the present exemplary case, the obstacle is another vehicle having an own on-board measuring device and which sends cooperative awareness messages about its own status. Thus, the vehicle being the obstacle can also serve as a second measuring device 102 sending a plurality of specification parameters. In the steps S900 to S905 of FIG. 9A, the obstacle parameter calculation unit 104 and/or the specification acquisition unit 802 receives a timestamp indicating the latest second obstacle parameter determination of the other vehicle (S900), a tracking time (observation length) of the other vehicle including the number of times the second obstacle parameters are acquired (S901), a variance of the other vehicle's velocity (S902), an AEB flag indicating if the automatic emergency brake of the other vehicle is activated or not (S903), a message type of each second obstacle parameter (S904) and a communication stability (S905) between the other vehicle and the obstacle parameter calculation unit 104 and/or the specification acquisition unit 802.

Moreover, FIG. 9B shows an initialization of the prediction model of the obstacle parameter calculation unit 104 according to step S207 in FIG. 2 which is carried out when the obstacle parameter calculation unit 104 and/or the specification acquisition unit 802 has received the plurality of specification parameters from the other vehicle.

After starting said process, a confidence offset CONF_OFFSET is set to 0 in step S910 by the obstacle parameter calculation unit 104. The confidence offset CONF_OFFSET may vary depending on the specification parameters and may be added to the confidence indicator CONF2 of the second obstacle parameters. In the following steps S920 to S970 the confidence offset CONF_OFFSET is adjusted by the obstacle parameter calculation unit 104 based on each of the plurality of specification parameters received from the other vehicle in the steps S900 to S905 of FIG. 9A. Then, in step S980 the prediction model of the obstacle parameter calculation unit 104 is initialized considering the adjusted confidence offset CONF_OFFSET in the confidence indicator CONF2. Then, step 207 of FIG. 2 is finished and the process described therein continues by verifying if the confidence indicator OP3[t][q].CONF is larger than the confidence threshold TH_CONF. Of course, instead of a vehicle, the second measuring device may be different obstacle or a different entity in general.

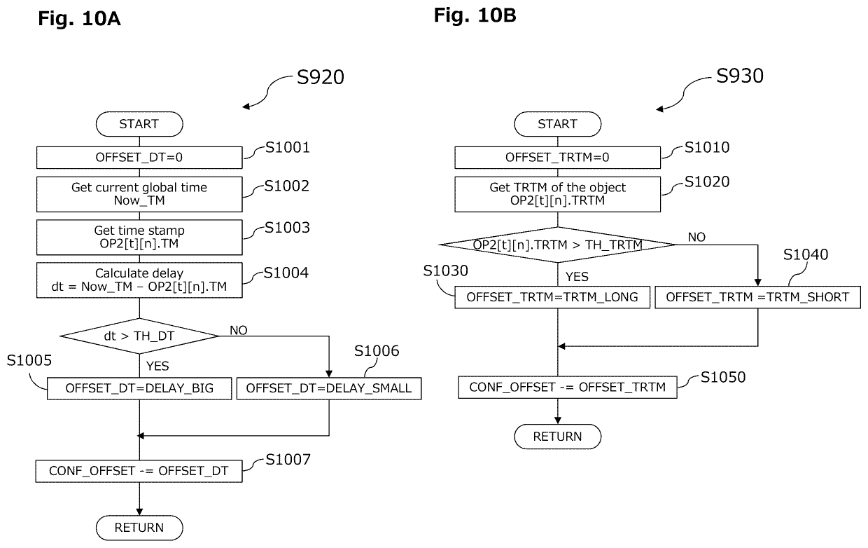

FIG. 10A and FIG. 10B each show a flow chart describing an example of adjusting the confidence indicator based on a specification parameter by the control device 1a depicted in FIG. 8.

In particular, the flow chart of FIG. 10A shows an adjustment of the confidence offset CONF_OFFSET based on the received timestamp indicating the latest second obstacle parameter determination of the other vehicle carried out in step S920 of FIG. 9B. After the start of the process, a confidence offset due to delay time OFFSET_DT is set to 0 in step S1001. Then, in the following steps S1002 and S1003, a current time NOW_TM and the received time stamp OP2[t][n].TM indicating the latest second obstacle parameter determination of the other vehicle are determined. Based on these a delay time dt for communicating the second obstacle parameters to the obstacle parameter calculation unit 104 is calculated in step S1004.

If the delay time dt is larger than a predetermined delay time threshold TH_DT, the confidence offset due to delay time OFFSET_DT is set to a value DELAY_BIG (S1005), and if the delay time dt is smaller than the predetermined delay time threshold TH_DT, the confidence offset due to delay time OFFSET_DT is set to a value DELAY_SMALL (S1006). Instead of the single value DELAY_BIG or DELAY_SMALL, the confidence offset due to the delay time OFFSET_DT can be determined by means of a characteristic curve or a formula depending on the delay time dt.

Finally, in step S1007, the confidence offset CONF_OFF is decreased by the value of the determined confidence offset due to delay time OFFSET_DT. The value DELAY_SMALL is smaller than the value DELAY_BIG, so that the confidence offset CONF_OFF is reduced by a smaller amount if the delay time dt is smaller than the predetermined delay time threshold TH_DT and is reduced by a larger amount if the delay time dt is larger than the predetermined delay time threshold TH_DT. Then the process of adjusting the confidence indicator based on the specification of the second obstacle parameters proceeds to step S930 of FIG. 9B shown in the flow chart depicted in FIG. 10B.

The flow chart of FIG. 10B shows an adjustment of the confidence offset CONF_OFFSET based on the received tracking time (observation length) of the other vehicle carried out in step S930 of FIG. 9B. After the start of the process, a confidence offset due to a tracking time of the other vehicle OFFSET_TRTM is set to 0 in step S1010. Then, in step S1020, the tracking time OP 2[t][n].TRTM is received from the other vehicle, which is subsequently compared with a predetermined tracking time threshold TH_TRTM.

If the tracking time OP2[t][n].TRTM is larger than the predetermined tracking time threshold TH_TRTM, the confidence offset due to the tracking time of the other vehicle OFFSET_TRTM is set to a value TRTM_LONG (S1030), and if the tracking time OP2[t][n].TRTM is smaller than the predetermined tracking time threshold TH_TRTM, the confidence offset due to the tracking time of the other vehicle OFFSET_TRTM is set to a value TRTM_SHORT (S1040).

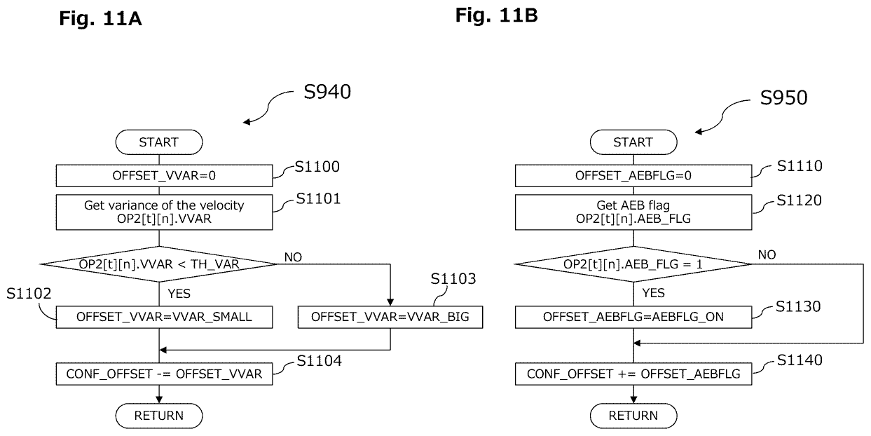

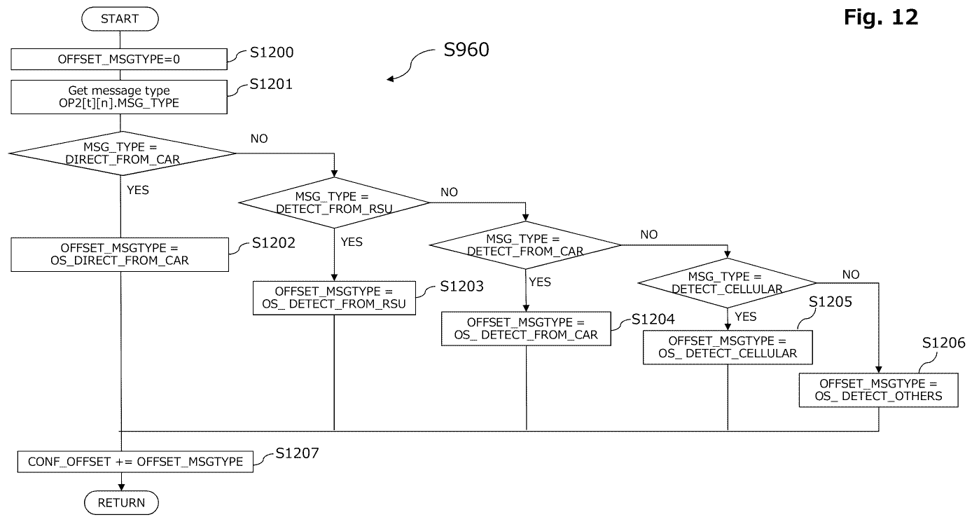

Finally, in step S1050, the confidence offset CONF_OFF is decreased (indicated by “−=”) by the value of the determined confidence offset due to a tracking time of the other vehicle OFFSET_TRTM. The value TRTM_LONG is smaller than the value TRTM_SHORT, so that the confidence offset CONF_OFF is reduced by a smaller amount if the tracking time OP2[t][n].TRTM of the other vehicle is larger than the predetermined tracking time threshold TH_TRTM and is reduced by a larger amount if the tracking time OP2[t][n].TRTM of the other vehicle is smaller than the predetermined tracking time threshold TH_TRTM. Then the process of adjusting the confidence indicator based on the specification of the second obstacle parameters proceeds to step S940 of FIG. 9B shown in the flow chart depicted in FIG. 11A.

FIG. 11A and FIG. 11B each show flow charts describing an example of adjusting the confidence indicator based on another specification parameter by the control device 1a depicted in FIG. 8.

In particular, the flow chart of FIG. 11A shows an adjustment of the confidence offset CONF_OFFSET based on a received variance of the other vehicle's velocity carried out in step S940 of FIG. 9B. After the start of the process, a confidence offset due to the variance of the other vehicle's velocity OFFSET_VVAR is set to 0 in step S1100. Then, in step S1101, the variance of the other vehicle's velocity OP2[t][n].VVAR is received from the other vehicle (or another entity acting as/having a second measuring device), and is subsequently compared with a predetermined variance threshold TH_VAR.

If the received variance of the other vehicle's velocity OP2[t][n].VVAR is smaller than the predetermined variance threshold TH_VAR, the confidence offset due to the variance of the other vehicle's velocity OFFSET_VVAR is set to a value VVAR_SMALL (S1102), and if the variance of the other vehicle's velocity OP2[t][n].VVAR is larger than the predetermined variance threshold TH_VAR, the confidence offset due to the variance of the other vehicle's velocity OFFSET_VVAR is set to a value VVAR_BIG (S1103).

Finally, in step S1104, the confidence offset CONF_OFF is decreased by the value of the determined confidence offset due to the variance of the other vehicle's velocity OFFSET_VVAR. The value VVAR_SMALL is smaller than the value VVAR_BIG, so that the confidence offset CONF_OFF is reduced by a smaller amount if the variance of the other vehicle's velocity OP2[t][n].VVAR is smaller than the predetermined variance threshold TH_VAR and is reduced by a larger amount if the variance of the other vehicle's velocity OP2[t][n].VVAR is larger than the predetermined variance threshold TH_VAR. Then the process of adjusting the confidence indicator based on the specification of the second obstacle parameters proceeds to step S950 of FIG. 9B shown in the flow chart depicted in FIG. 11B.

The flow chart of FIG. 11B shows an adjustment of the confidence offset CONF_OFFSET based on the received AEB flag indicating if the automatic emergency brake of the other vehicle is activated or not carried out in step S950 of FIG. 9B. After the start of the process, a confidence offset due to a setting of the AEB flag of the other vehicle OFFSET_AEBFLG is set to 0 in step S1110. Then, in step S1120, the setting of the AEB flag of the other vehicle is received. If the AEB flag OP2[t][n].AEB_FLG is set to 1, which means that the automatic emergency brake of the other vehicle is activated, the confidence offset due to a setting of the AEB flag of the other vehicle OFFSET_AEBFLG is set to a value AEBFLG_ON in step S1130 and the confidence offset CONF_OFFSET is increased (“+=”) by this value in step S1140. If the AEB flag OP 2[t][n].AEB_FLG is set to 0, which means that the automatic emergency brake of the other vehicle is deactivated, the confidence value CONF_OFFSET is not increased due to the setting of the AEB flag of the other vehicle. Then the process of adjusting the confidence indicator based on the specification of the second obstacle parameters proceeds to step S960 of FIG. 9B shown in the flow chart depicted in FIG. 12.

FIG. 12 shows a flow chart describing an example of adjusting the confidence indicator based on one more specification parameter by the control device 1a depicted in FIG. 8.

In particular, the flow chart of FIG. 12 shows an adjustment of the confidence offset CONF_OFFSET based on the received message type of each second obstacle parameter carried out in step S960 of FIG. 9B. After the start of the process, a confidence offset due to a message type of a second obstacle parameter OFFSET_MSGTYPE is set to 0 in step S1200. Then, in step S1201, the message type OP2[t][n].MSG.TYPE of the second obstacle parameter is received from the other vehicle (or the like in other examples).

If the message type is a cooperate awareness message providing information about the other vehicle (MSG_TYPE=DIRECT_FROM_CAR), the confidence offset due to the message type of the second obstacle parameter OFFSET_MSGTYPE is set to a value OS_DIRECT_FROM_CAR in step S1202.

If not, it is checked whether the message is received from a road side unit (MSG_TYPE=DETECT_FROM_RSU). If this is the case, the confidence offset due to the message type of the second obstacle parameter OFFSET_MSGTYPE is set to a value OS_DETECT_FROM_RSU in step S1203.

If not, it is checked whether the message is a collective perception message received from the other vehicle providing information about other objects (MSG_TYPE=DETECT_FROM_CAR). If this is the case, the confidence offset due to the message type of the second obstacle parameter OFFSET_MSGTYPE is set to a value OS_DETECT_FROM_CAR in step S1204.

If not, it is checked whether the message is received from a mobile device (MSG_TYPE=DETECT_CELLULAR). If this is the case, the confidence offset due to the message type of the second obstacle parameter OFFSET_MSGTYPE is set to a value OS_DETECT_CELLULAR in step S1205.

If not, it is checked whether the message is received from any other device and the confidence offset due to the message type of the second obstacle parameter OFFSET_MSGTYPE is set to a value OS_DETECT_OTHERS in step S1206.

Depending on the message type, the confidence offset CONF_OFFSET is increased by the value of the confidence offset due to the message type of the second obstacle parameter OFFSET_MSGTYPE in step S1207. In particular, the following order from large to small may apply with respect to the values of the confidence offset due to the message type of the second obstacle parameter OFFSET_MSGTYPE: OS_DIRECT_FROM_CAR>OS_DETECT_FROM_RSS>OS_DETECT_FROM_CAR>OS_DETECT_CELLULAR>OS_DETECT_OTHERS.

In other words, the confidence offset CONF_OFFSET may be increased by the largest amount if the message type is a cooperate awareness message that provides direct information about the other vehicle, and by the smallest amount if the message is received from a device other than another vehicle, a roadside unit, or a mobile device.

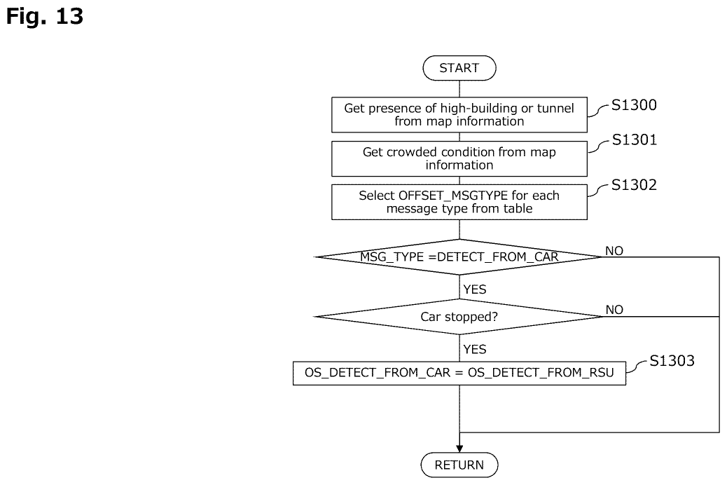

FIG. 13 shows a flow chart describing an example of adjusting the confidence indicator based on map information by the control device 1a depicted in FIG. 8. In particular, FIG. 13 shows as to how a confidence offset due to the message type of the second obstacle parameter OFFSET_MSGTYPE may be changed depending on environmental conditions of the vehicle determined from map information stored in the map information storage 800. After starting the process, in step S1300, map information providing information about the presence of high buildings or an enclosed environment, such as a tunnel, in the area surrounding the vehicle are received by the obstacle parameter calculation unit 104 and/or the specification acquisition unit 802. Further, in step S1301, information on whether the vehicle is driving under crowded road conditions are received as map information. Then, in step S1302, a value for a confidence offset due to the message type of the second obstacle parameter OFFSET_MSGTYPE, such as OS_DIRECT_FROM_CAR, OS_DETECT_FROM_RSS, OS_DETECT_FROM_CAR, OS_DETECT_CELLULAR and/or OS_DETECT_OTHERS, is selected for each message type from a table. The table of OFFSET_MSGTYPE values may be stored, for example, in the map information storage 800 of the control device. If the message type is a cooperate awareness message providing information about the other vehicle (MSG_TYPE=DIRECT_FROM_CAR), it is checked whether the other vehicle has stopped. If this is the case, the value OS_DIRECT_FROM_CAR is set equal to the value OS_DETECT_FROM_RSS, as the other vehicle now acts like a road side unit. If not, the OFFSET_MSGTYPE values can remain constant.

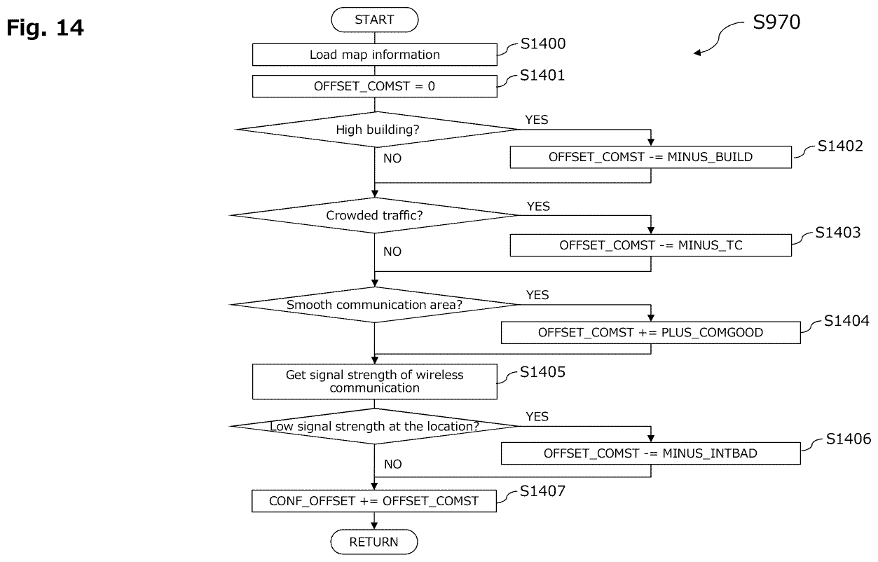

FIG. 14 shows a flow chart describing an example of adjusting the confidence indicator based on one more specification parameter by the control device 1a depicted in FIG. 8.

In particular, the flow chart of FIG. 14 shows an adjustment of the confidence offset CONF_OFFSET based on the received communication stability between the other vehicle and the obstacle parameter calculation unit 104 and/or the specification acquisition unit 802 carried out in step S970 of FIG. 9B. After the start of the process, in step S1400, map information is loaded from the map information storage 800 and delivered to the obstacle parameter calculation unit 104 and/or the specification acquisition unit 802. Then, in step S1401, a confidence offset due to a communication stability between the other vehicle and the obstacle parameter calculation unit 104 and/or the specification acquisition unit 802 OFFSET_COMST is set to 0. Subsequently, it is checked in the map information whether high buildings are present in an area surrounding the vehicle. If this is the case, a value of the confidence offset due to the communication stability OFFSET_COMST is decreased by a value MINUS_BUILD in step S1402.

If not, it is checked whether crowded traffic is present in the area surrounding the vehicle. If this is the case, the value of the confidence offset due to the communication stability OFFSET_COMST is decreased by a value MINUS_TC in step S1403.

If not, it is checked whether the vehicle V is driving in a smooth communication area without interferences of obstacles and/or other devices. If this is the case, the value of the confidence offset due to the communication stability OFFSET_COMST is increased by a value PLUS_COMGOOD in step S1404.

If not, a signal strength of the wireless communication around the vehicle is received in step S1405, and it is checked whether the signal strength is low. If this is the case, the value of the confidence offset due to the communication stability OFFSET_COMST is decreased by a value MINUS_INTBAD in step S1406. Finally the confidence offset CONF_OFFSET is increased by the resulting value of the confidence offset due to the communication stability OFFSET_COMST in step S1407. Then the process of adjusting the confidence indicator based on the specification of the second obstacle parameters proceeds to step S980 of FIG. 9B, in which the prediction model of the obstacle parameter calculation unit 104 is initialized with the confidence offset CONF_OFFSET.

Of course, it is possible to combine some or select one or some of the confidence adjustment methods as described in connection with the previous Figures.

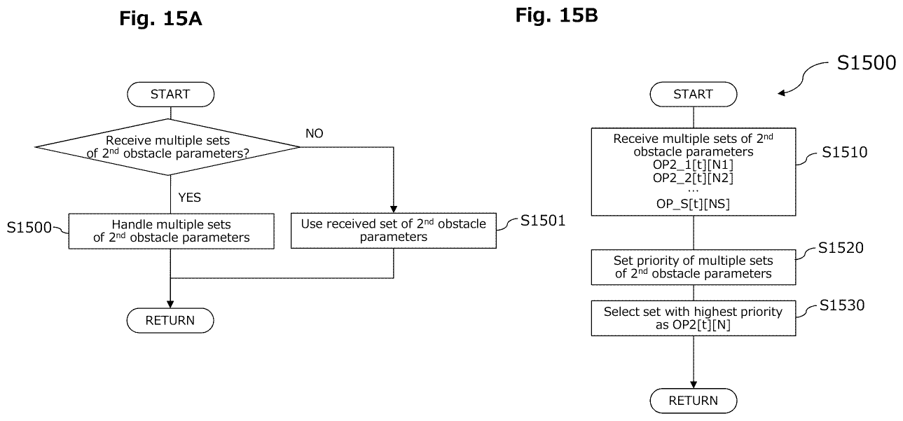

FIG. 15A and FIG. 15B each show a flow chart describing an example of processing a plurality of second obstacle parameters detected by more than one second measuring device by the control device 1a depicted in FIG. 8.

In particular FIG. 15A shows a process carried out in step S204 of the initializing procedure depicted in FIG. 2, in case that multiple sets of second obstacle parameters OP2[t][N] are received from multiple second measuring devices. After starting the process, it is determined if more than one plurality/set of second obstacle parameters is received from more than one second measuring device. If this should be the case, the multiple sets of second obstacle parameters are processed in step S1500. If not, the received set of second obstacle parameters is used in step S1501. Then the process returns to step S205 of FIG. 2, in which the current second obstacle parameters are calculated/predicted.

Moreover, FIG. 15B shows as to how the multiple sets of second obstacle parameters are processed in step S1500 of FIG. 15A. After the start of the process, the multiple sets of second obstacle parameters are received in step S1510. Subsequently a priority of the multiple sets is determined in step S1520. Next, in step S1530, the set of second obstacle parameter having the highest priority is selected as the plurality of second obstacle parameters. Afterwards, the process returns to step S205 of FIG. 2, in which the current second obstacle parameters are calculated/predicted.

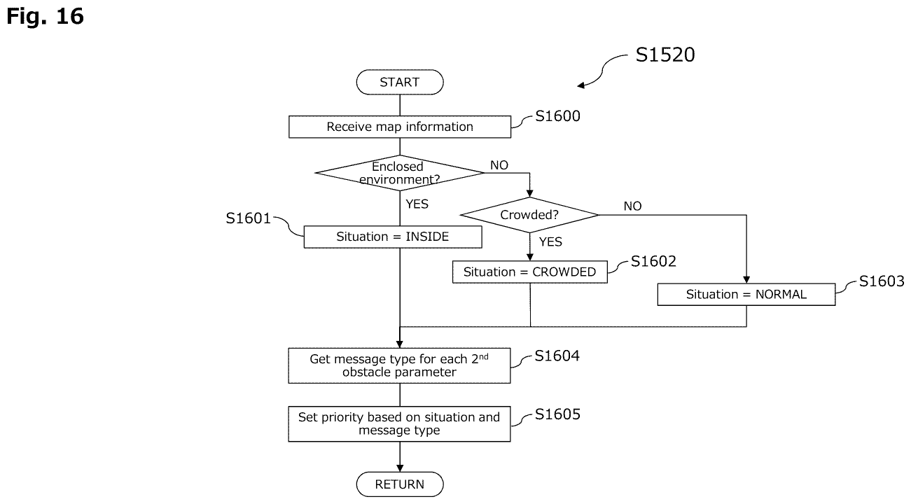

FIG. 16 shows a flow chart describing an example of prioritizing the plurality of second obstacle parameters detected by more than one second measuring device by the control device 1a depicted in FIG. 8.

In particular, FIG. 16 shows a preferred example as to how the priority of the multiple sets of second obstacle parameters can be determined in step 1520 of FIG. 15B. After the start of the process, map information is received from the map information storage in step S1600. Based on the received map information it is determined whether the vehicle V is driving in an enclosed environment such as a tunnel or the like. If this is the case, a situation of the vehicle is set to a value INSIDE, representing a decreased reliability of a wireless communication around the vehicle. If not, it is further determined whether the vehicle is driving in a crowded environment. If this is the case, a situation of the vehicle is set to a value CROWDED in step S1602, also representing a decreased reliability of the wireless communication around the vehicle. If not, the situation of the vehicle is set to a value NORMAL in step S1603, representing an average reliability of the wireless communication around the vehicle. Next, in step S1604 a message type for each second obstacle parameter is received and then the priority of each set of second obstacle parameters is determined based on the situation value and the message types in step 1605. In other words, the set of second obstacle parameters that provides the highest reliability is attributed with the highest priority. Subsequently, the process returns to step S1530 of FIG. 15B, in which the set of second obstacle parameters having the highest priority is selected as the plurality of second obstacle parameters to be used.

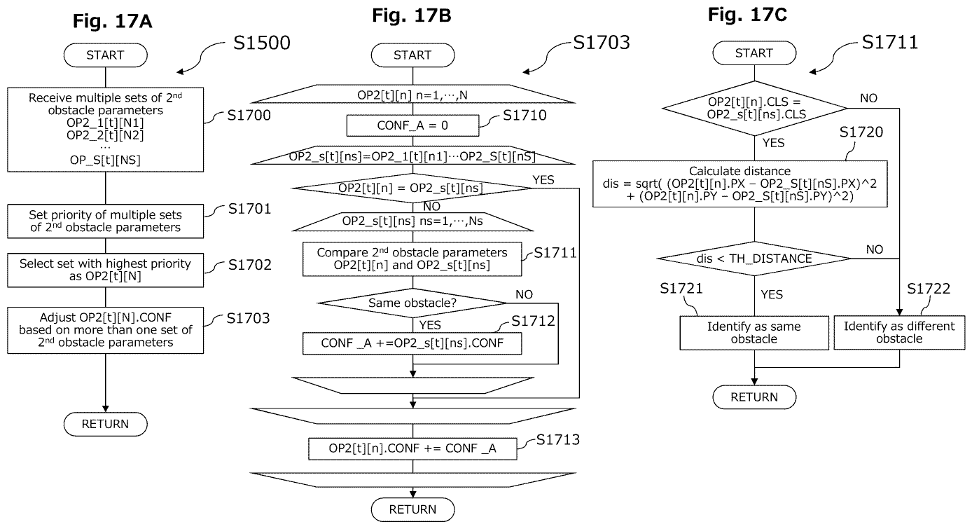

FIG. 17A to FIG. 17C each show a flow chart describing another example of processing a plurality of second obstacle parameters detected by more than one second measuring device by the control device 1a depicted in FIG. 8.

In particular, FIG. 17A shows the steps S1700 to S1702, which are equal to the steps S1510 to S1530 of FIG. 15B. In addition, FIG. 17A includes a further step S1703, in which the confidence indicator OP2[t][N].CONF of the second obstacle parameters is adjusted based on more than one set of second obstacle parameters.

The process for adjusting the confidence indicator OP2[t][N].CONF in step S1703 is shown in FIG. 17B. After the start of the method, a calculation loop is executed by the obstacle parameter calculation unit 104, in which a confidence indicator CONF_A is determined based on each second obstacle parameter OP2[t][n] with n=1, . . . , N of at least two sets of second obstacle parameters. In step S1710 of the calculation loop, the confidence indicator CONF_A is initially set to 0. Then, it is checked whether one and another set of second obstacle parameters OP2[t][n] and OP2_s[t][ns] have been received, wherein the variables n and ns indicate the one and the other second obstacle parameters, respectively. If so, the two sets of second obstacle parameters are compared in step S1711 to determine if the two different second measuring devices 102 have detected the same obstacle. If the result is positive, the confidence indicator CONF_A is increased by the value of the confidence indicator OP2_s[t][n].CONF of the other set of second obstacle parameters. If the result is negative, the confidence indicator CONF_A remains at 0.

In step 1713, the confidence indicator of the one set of second obstacle parameters OP2[t][n].CONF is increased by the value of the confidence indicator CONF_A. Thus, the confidence indicator OP2[t][n].CONF of the one set of second obstacle parameters is increased if both second measuring devices 102 have detected the same obstacle.

FIG. 17C shows a process of determining whether both second measuring devices 102 have detected the same obstacle carried out in step S1711 of FIG. 17B. After the start of the process, it is checked whether the one and the other second measuring device have detected an obstacle of the same type/class, wherein the term CLS refers to a type/class of an obstacle. If so, in step S1720 a distance dis between the positions of the obstacles detected by the one and the other second measuring device is calculated using a least square method (sqrt—square root), wherein the terms PX and PY refer to x- and y coordinates of the obstacles' position. If the calculated distance dis is smaller than a predetermined distance threshold TH_DISTANCE, the detected obstacles are identified as the same obstacle in step S1721, and the process illustrated in the flow chart of FIG. 17B continuous with step S1712, in which the confidence indicator CONF_A is increased by the value of the confidence indicator OP_s[t][n].CONF of the other set of second obstacle parameters. However, if the distance dis is larger than the predetermined distance threshold TH_DISTANCE, two different obstacles are identified in step S1722, and the confidence indicator CONF_A remains at 0. The latter also applies if a different type of obstacle has been determined in the one and the other set of second obstacle parameters in the beginning of the process.

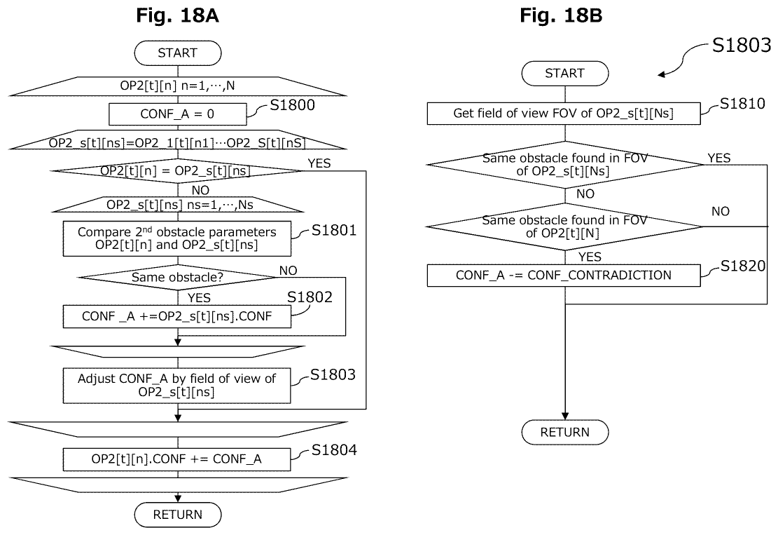

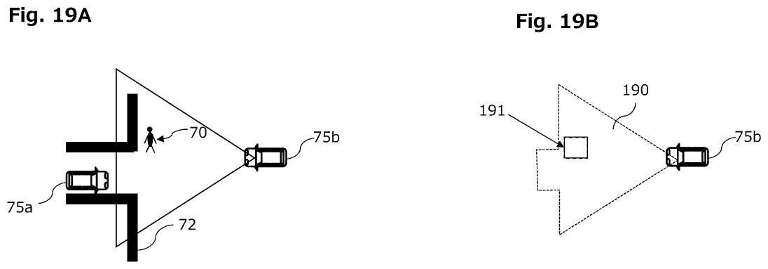

FIG. 18A and FIG. 18B each show a flow chart describing an example of adjusting the confidence indicator based on different fields of view of more than one second measuring device by the control device 1a depicted in FIG. 8.

Thereby, the steps S1800 to S1802 and step S1804 are identical to the steps S1710 to S1713 of FIG. 17B. In addition, FIG. 18A includes the step S1803, in which the confidence indicator CONF_A is adjusted based on the field of view of the other second measuring device. The process of adjusting the confidence indicator CONF_A is in turn described in FIG. 18B.

In particular, after the start of the process, the field of view FOV of the other second measuring device determining the other set of second obstacle parameters OP_s[t][Ns] is received in step S1810, wherein the term Ns indicates a matrix the of other second obstacle parameters. Subsequently, it is checked whether the detected obstacle has been recognized in the field of view of the other second obstacle device. If so, the confidence indicator CONF_A remains constant and the process returns to step S1804 of FIG. 18A. If not, it is checked whether the determined obstacle has been recognized in the field of view of the one second measuring device 102. If this is not the case, the determined obstacle has not been recognized in any field of view of the two second measuring devices so that the confidence indicator CONF_A remains constant and the process returns to step S1804 of FIG. 18A.

However, if the determined obstacle has been recognized in the field of view of the one second measuring device, a contradiction between both second measuring devices is determined and the confidence indicator CONF_A is decreased by a value CONF_CONTRADICTION in step S1820 of FIG. 18B before the process returns to step S1804 of FIG. 18A.

FIG. 19A and FIG. 19B schematically show an example of a driver assistance employment situation when an obstacle is detected by a second measuring device 102 using the control device 1a depicted in FIG. 8. In particular, FIG. 19A shows a vehicle V (here: 75a) driving between two boundaries 72 (e.g. buildings or the like), such that a pedestrian 70 who walks behind one of the boundaries 72 cannot be detected by an on-board sensor 100 of the vehicle 75a. However, the pedestrian 70 is recognized in a field of view of an on-board sensor of another vehicle 75b, e.g. the other vehicle 75b driving in a different direction and/or position.

FIG. 19B shows the field of view 190 of the on-board sensor of the other vehicle 75b and the detection result 191 achieved by its on-board sensor. Comparing FIGS. 19A and 19B, it can be seen that the position of the pedestrian 70 is correctly captured by the detection result 191 of the on-board sensor of the other vehicle 75b while the vehicle 75a cannot “see” the pedestrian 70 with its on-board sensor, such as a stereo-camera or the like.

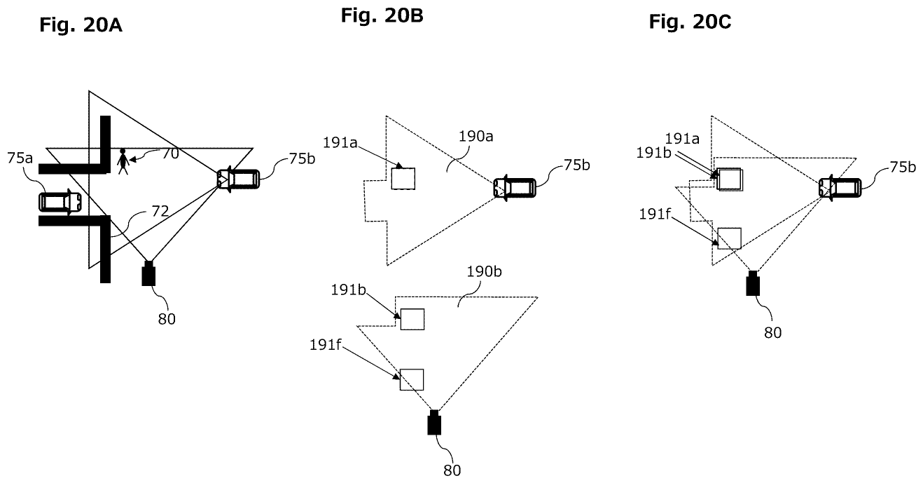

FIGS. 20A to 20C further schematically show an example if an obstacle is detected by more than one second measuring device 102 using the control device 1a depicted in FIG. 8.

In particular, FIG. 20A shows the vehicle V (here: 75a), the pedestrian 70, the boundaries 72 and the other vehicle 75b as already depicted in FIG. 19A. In addition, FIG. 20A shows a road side unit 80 (e.g. a traffic camera or the like) with a field of view perpendicular (for example) to the field of view of the on-board sensor of the other vehicle 75b.

FIG. 20B shows the field of view 190a of the on-board sensor of the other vehicle 75b with the detection result 191a as already shown in FIG. 19B. In addition, FIG. 20B shows the field of view 190b of the road side unit 80. Based on the field of view 190b of the road side unit two different detection results 191b, 191f have been captured. Comparing FIGS. 20A and 20B, it can be seen that the position of the pedestrian 70 is correctly captured by the detection result 191b and incorrectly captured by the detection result 191f.

Finally, FIG. 20C shows the result of considering the fields of view 190a, 190b of the two second measuring devices 102, on-board sensor of the other vehicle 75b and road side unit 80.

If the detection result 190b of the road-side unit and the detection result 190a of the on-board sensor were taken into account, the position of the pedestrian would have been correctly detected by both second measuring devices, and the confidence indicator could be increased. However, if the detection result 190f of the road-side unit and the detection result 190a of the on-board sensor were taken into account, there would be a contradiction between the two second measuring devices 75b, 80, and the confidence indicator would have to be decreased.

FIG. 21 schematically shows a control device 1b according to another example of the disclosed subject matter. In addition to the control device shown in FIG. 8, the control device of FIG. 21 includes an intervention enabling unit 105a and a warning enabling unit 105b in place of a single enabling unit, and an associated intervention activation unit 106a and warning activation unit 106b, respectively, in place of a single activation unit. The warning enabling unit 105b may calculate a warning decision parameter based on the plurality of third obstacle parameters, which when falling below a predetermined warning activation threshold may cause a warning activation by the warning activation unit 106b. Accordingly, the intervention enabling unit 105a may calculate an intervention decision parameter based on the plurality of third obstacle parameters, which when falling below a predetermined intervention activation threshold may cause an intervention activation by the intervention activation unit 106b. Preferably, the predetermined warning activation threshold may be larger than the predetermined intervention activation threshold. For example, if the warning and/or the intervention decision parameter is a time-to-collision, the warning activation threshold may include a larger time-to-collision value than the intervention activation threshold. Thus, a warning may be activated earlier than an intervention. As noted in connection with FIG. 8, other not depicted variations are possible in which, e.g., the storage 800 and/or the signal strength acquisition unit 801 are part of the control device 1b or in which they may be located remotely/outside of the vehicle V.

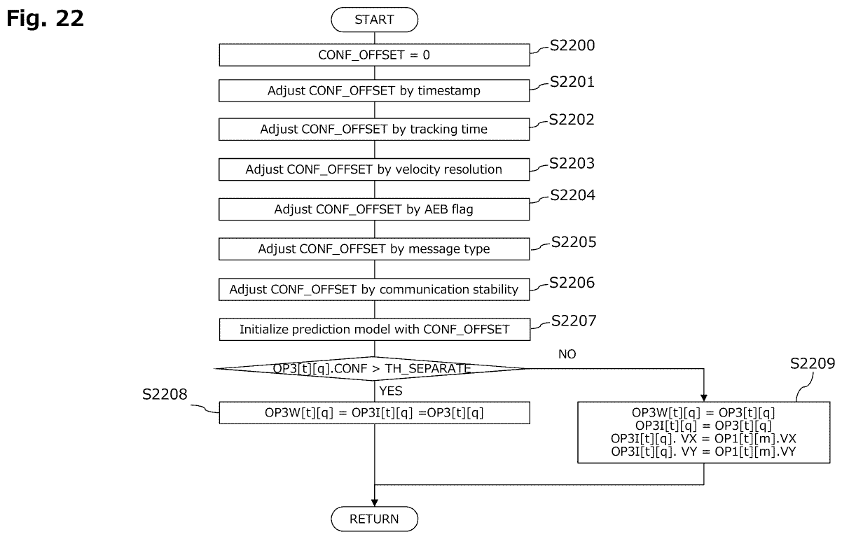

FIG. 22 shows a flow chart describing an example of receiving a specification of a plurality of second obstacle parameters and adjusting a confidence indicator of the second obstacle parameters based on the received specification by the control device depicted in FIG. 21.

In particular, FIG. 22 shows an initialization of the prediction model of the obstacle parameter calculation unit 104 with the confidence offset CONF_OFFSET when the obstacle parameter calculation unit 104 and/or the specification acquisition unit 802 has received a plurality of specification parameters from a second measuring device 102 (it is noted again that the parameters may also be received at the unit 104 from the respective obstacle parameter acquisition unit which has been described above and which is depicted in FIG. 8 or 21), which may be (or included in) another vehicle. The specification parameters based on which the confidence offset CONF_OFFSET is adjusted according to FIG. 22 are identical to that shown in the FIGS. 9A and 9B. In particular, the steps S2200 to S2207 of FIG. 22 are identical to the steps S910 to S970 of FIG. 9B, which means that each received specification parameter is considered in terms of adjusting the confidence offset CONF_OFFSET in the steps S2201 to S2207, and that afterwards the prediction model is initialized with the adjusted confidence offset CONF_OFFSET in step S2207. In addition to the initializing process shown in FIG. 9B, the obstacle parameter calculation unit 104 checks after the initialization in step S2207 whether a confidence indicator OP3[t], [q].CONF of the third obstacle parameter is larger than a second predetermined threshold TH_SEPARATE. If this is the case, the prediction model is initialized with same third obstacle parameters in step S2208 regardless if the third obstacle parameters are used for calculating a warning decision parameter, an intervention decision parameter or a general decision parameter based on which a driver assistance may be enabled (OP3W[t][q]=OP3I[t][q]=OP3I[t][q]). If not, two separate sets of third obstacle parameter units are initialized in step S2209, wherein the third obstacle parameters OP3W[t][q] used for calculating a warning decision parameter are based on first and second obstacle parameters, while third obstacle parameters OP3I[t][q] used for calculating an intervention decision parameter are only based on first obstacle parameters.

This means, that a warning (or the activation thereof) may be enabled/triggered based on a combination of position parameters taken from the plurality of first obstacle parameters and movement parameters taken from the plurality of second obstacle parameters even if the confidence indicator OP3[t],[q].CONF is below the second predetermined threshold TH_SEPARATE. However, in this case, an intervention in a driver's driving behaviour may be performed only based on the first obstacle parameters, which may preferably be determined by an on-board measuring device of the vehicle. This ensures that in the case of an external measuring device which may have an unknown reliability or a reliability below a predefined threshold, the entire control of the driver assistance system may remain with the vehicle.

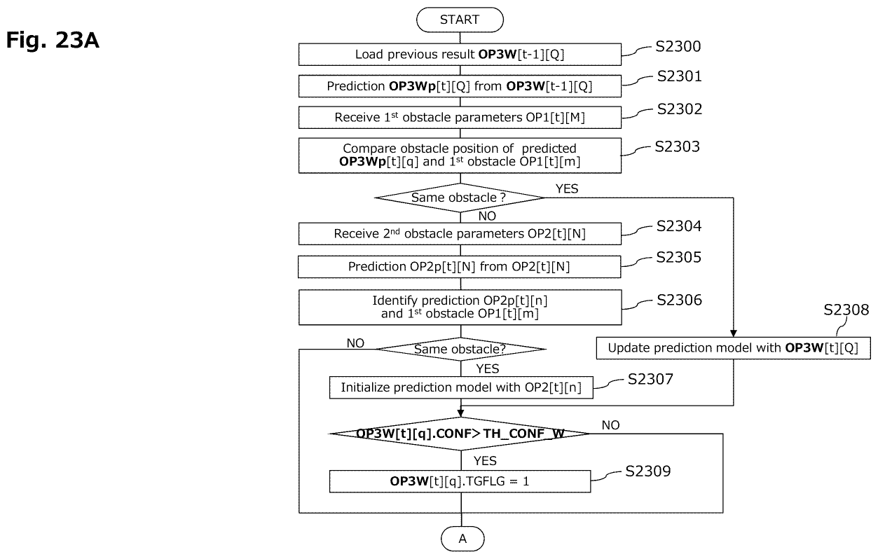

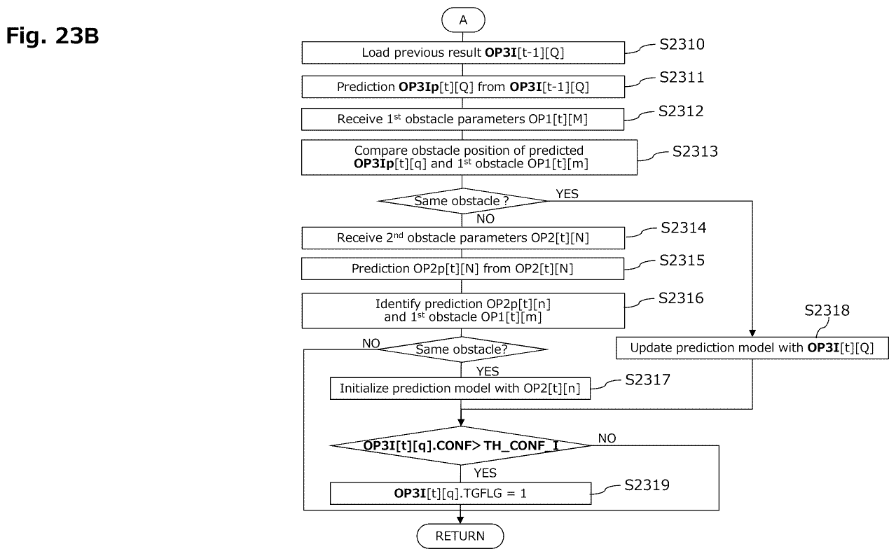

FIG. 23A shows a flow chart describing an example of an initializing process of the control device depicted in FIG. 21. In particular FIG. 23A shows an initializing process of the prediction model included in the obstacle parameter calculation unit 104 of the control device depicted in FIG. 21 with regard to a calculation of third obstacle parameters OP3W[t][q] used for calculating a warning decision parameter.

For verifying whether an initializing of the prediction model is needed, a previously calculated plurality/set of third obstacle parameters OP3W[t−1][Q] is loaded by the obstacle parameter calculation unit 104 in step S2300 of FIG. 23A, wherein the variable Q indicates a matrix of third obstacle parameters and the variable t indicates a time.

In the subsequent step S2301, the prediction model of the obstacle parameter calculation unit 104 calculates a present set of third obstacles parameters OP3Wp[t][Q] based on the third obstacle parameters OP3W[t−1][Q] determined in the previous step. Then, in step S2302, the obstacle parameter calculation unit 104 receives a current set of first obstacle parameters OP1[t][M], wherein the variable M indicates a matrix of first obstacle parameters.

Next, in step S2303, the obstacle parameter calculation unit 104 compares an obstacle position from the present set of third obstacle parameters OP3Wp[t][Q] with an obstacle position from the set of first obstacle parameters OP1[t][M].

If both positions are identical, the prediction model of the obstacle parameter calculation unit 104 is updated in step S2308 with the calculated current set of third obstacle parameters OP3Wp[t][Q] and the position parameters OP1[t][m] of the plurality of first obstacle parameters.

Additionally, in step S2308, a confidence indicator of the third obstacle parameters OP3W[t][q].CONF is incremented (not depicted) as the obstacle parameter calculation unit 104 has received a new set of first obstacle parameters from the on-board sensor 100. Each received set of first obstacle parameters from the on-board sensor 100 increases the reliability of the obstacle detection, therefore the confidence indicator OP3W[t][q].CONF is incremented each time the obstacle parameter calculation unit 104 receives new first obstacle parameters from the on-board sensor 100.

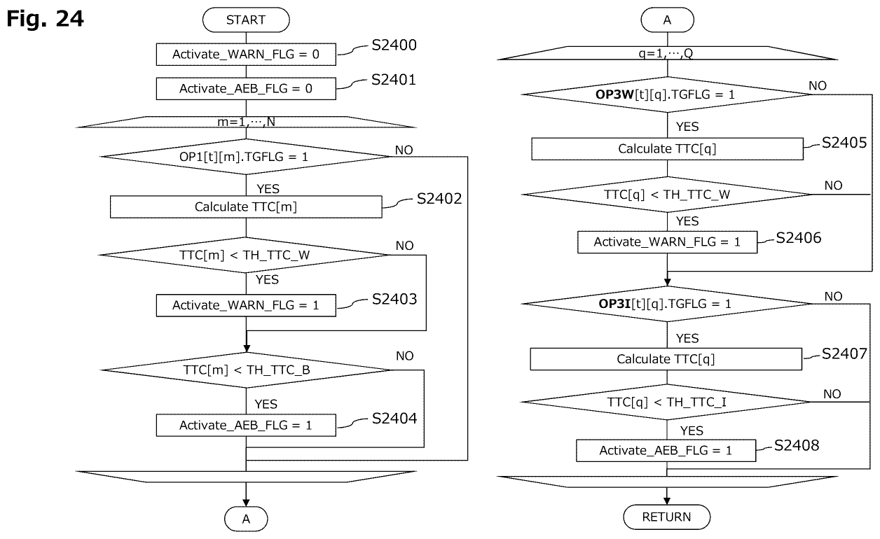

Then, it is verified whether the confidence indicator OP3W[t][q].CONF is higher than a predetermined warning confidence threshold TH_CONF_W, and if this is the case, a confidence flag of the third obstacle parameters OP3W[t][q].TGFLG is set to 1 in step S2309, to indicate that the plurality of third obstacle parameters can be used by the enabling unit 105 for determining a time-to-collision TTC[Q] as warning decision parameter (see FIG. 24).

However, if the position parameters of the first and third obstacle parameters are not identical, the obstacle parameter calculation unit 104 receives the plurality of second obstacle parameters OP2[t][N] determined by the external sensor 102 in step S2304, wherein the variable N indicates a matrix of second obstacle parameters. In the next step S205, the prediction model of the obstacle parameter calculation unit 104 calculates a present set of second obstacles parameters OP2p[t][N] based on the determined second obstacle parameters OP2[t][N], as the communication between the external sensor 102 and the obstacle parameter calculation unit 104 involves a delay.

Next, the obstacle parameter calculation unit 104 compares a position of an obstacle from the present set of second obstacle parameters OP2p[t][N] with a position of an obstacle from the set of first obstacle parameters OP1[t][M] in step S2306.

If both positions are identical, in step S2307, the prediction model of the obstacle parameter calculation unit 104 is initialized with the movement parameters OP2p[t][n] of the current second obstacle parameters OP2p[t][N] and the position parameters OP1[t][m] of the first obstacle parameters.

Afterwards, the process continues as described above by verifying whether the confidence indicator OP3W[t][q].CONF is higher than the predetermined warning confidence threshold TH_CONF_W. If so, the confidence flag of the third obstacle parameters OP3W[t][q].TGFLG is set to 1 in step S2309 to indicate that the plurality of third obstacle parameters can be used by the warning enabling unit 105b to determine a time to collision TTC[Q] as a decision parameter (see FIG. 24).

After the confidence flag of the third obstacle parameters OP3W[t][q].TGFLG is set to 1 in step S2309, the process continuous in FIG. 23B.

FIG. 23B shows an initializing process of the prediction model included in the obstacle parameter calculation unit 104 of the control device 1b depicted in FIG. 21 with regard to a calculation of third obstacle parameters OP3I[t][q] used for calculating a intervention decision parameter.

For verifying whether an initializing of the prediction model is needed, a previously calculated plurality/set of third obstacle parameters OP3I[t−1][Q] is loaded by the obstacle parameter calculation unit 104 in step S2310, wherein the variable Q indicates a matrix of third obstacle parameters and the variable t indicates a time.

In the subsequent step S2311, the prediction model of the obstacle parameter calculation unit 104 calculates a present set of third obstacles parameters OP3Ip[t][Q] based on the third obstacle parameters OP3I[t−1][Q] determined in the previous step. Then, in step S2312, the obstacle parameter calculation unit 104 receives a current set of first obstacle parameters OP1[t][M], wherein the variable M indicates a matrix of first obstacle parameters.

Next, in step S2313, the obstacle parameter calculation unit 104 compares an obstacle position from the present set of third obstacle parameters OP3Ip[t][Q] with an obstacle position from the set of first obstacle parameters OP1[t][M].

If both positions are identical, the prediction model of the obstacle parameter calculation unit 104 is updated in step S2318 with the calculated current set of third obstacle parameters OP3Ip[t][Q] and the position parameters OP1[t][m] of the plurality of first obstacle parameters.

Additionally, in step S208, a confidence indicator of the third obstacle parameters OP3I[t][q].CONF is incremented (not depicted) as the obstacle parameter calculation unit 104 has received a new set of first obstacle parameters from the on-board sensor 100. Each received set of first obstacle parameters from the on-board sensor 100 increases the reliability of the obstacle detection, therefore the confidence indicator OP3I[t][q].CONF is incremented each time the obstacle parameter calculation unit 104 receives new first obstacle parameters from the on-board sensor 100.

Then, it is verified if the confidence indicator OP3I[t][q].CONF is higher than a predetermined intervention confidence threshold TH_CONF_1, and if this is the case, a confidence flag of the third obstacle parameters OP3I[t][q].TGFLG is set to 1 in step S2319, to indicate that the plurality of third obstacle parameters can be used by the enabling unit 105 for determining a time-to-collision TTC[Q] as decision parameter (see FIG. 24).

However, if the position parameters of the first and third obstacle parameters are not identical, the obstacle parameter calculation unit 104 receives the plurality of second obstacle parameters OP2[t][N] determined by the external sensor 102 in step S2314, wherein the variable N indicates a matrix of second obstacle parameters. In the next step S2315, the prediction model of the obstacle parameter calculation unit 104 calculates a present set of second obstacles parameters OP2p[t][N] based on the determined second obstacle parameters OP2[t][N], as the communication between the external sensor 102 and the obstacle parameter calculation unit 104 involves a delay.

Next, the obstacle parameter calculation unit 104 compares a position of an obstacle from the present set of second obstacle parameters OP2p[t][N] with a position of an obstacle from the set of first obstacle parameters OP1[t][M] in step S206.

If both positions are identical, in step S2317, the prediction model of the obstacle parameter calculation unit 104 is initialized with the movement parameters OP2p[t][n] of the current second obstacle parameters OP2p[t][N] and the position parameters OP1[t][m] of the first obstacle parameters.

Afterwards, the process continues as described above by verifying whether the confidence indicator OP3I[t][q].CONF is higher than the predetermined intervention confidence threshold TH_CONF_I. If so, the confidence flag of the third obstacle parameters OP3I[t][q].TGFLG is set to 1 in step S2319 to indicate that the plurality of third obstacle parameters can be used by the enabling unit 105 to determine a time to collision TTC[Q] as an intervention decision parameter (see FIG. 24).

FIG. 24 shows a flow chart describing an example of enabling a warning and/or an intervention as driver assistance by the control device 1b depicted in FIG. 21.

After starting the process, an activation flag WARN_FLG of a warning and an activation flag AEB_FLG of an automatic emergency brake (AEB), are set to 0 in the steps S2400 and 2401, which means that a warning device and the automatic emergency brake are deactivated.

In the following calculation loop, the warning enabling unit 105a of the control device shown in FIG. 21 checks whether a confidence flag TGFLG=1 is set for each of the plurality of first obstacle parameters m=1, . . . , N, and calculates a time-to-collision TTC[m] based on each of the plurality of first obstacle parameters m=1, . . . , N if the result is positive (S2402).

In case the determined time-to-collision TTC [m] is smaller than a predetermined warning activation threshold TH_TTC_W, the warning enabling unit 105a activates an warning by setting the activation flag WARN_FLG to 1 in step S2403.

Next, it is checked by the intervention enabling unit 105b whether the time-to-collision TTC [m] is smaller than a predetermined intervention activation threshold TH_TTC_I. If this is the case, the activation flag of the automatic emergency brake AEB_FLG is set to 1 in step S2404 for activating the automatic emergency brake.

In case that any of the above described checks is negative, the process exits the current calculation loop and proceeds further to a second calculation loop in which the time to collision TTC[q] is calculated based on the plurality of third obstacle parameters q=1, . . . , Q.

In the second calculation loop including the steps S2405 to 2408. the above described process is carried out for the plurality of third obstacle parameters q=1, . . . , Q. In step S2405, a time-to-collision TTC[q] is calculated by the warning enabling unit 105a based on the plurality of third obstacle parameters q=1, . . . , Q, and in step S604, a warning is activated by the warning enabling unit (WARN_FLG=1) if the determined time-to-collision TTC [q] is smaller than the predetermined warning activation threshold TH_TTC_W.

Next, it is verified whether a confidence flag TGFLG=1 is set for each of the third obstacle parameters OP3I[t][q. If so, the intervention enabling unit 105b calculates a time-to collision TTC[q] based on each of the plurality of third obstacle parameters q=1, . . . Q.

In case the determined time-to-collision TTC [q] is smaller than a predetermined intervention activation threshold TH_TTC_I, the intervention enabling unit 105b activates an automatic emergency braking by setting the activation flag AEB_FLG to 1 in step S2408.

If any of the checks carried out in the second calculation loop is negative, the process returns to step S2400 and proceeds further until the warning flag WARN_FLG and/or the activation flag AEB_FLG of the automatic emergency brake is set to 1.

This means that a warning as well as an automatic emergency braking can be activated either by a time-to-collision TTC[m] calculated based on the first obstacle parameters and/or by a time-to-collision TTC[q] calculated based on the third obstacle parameters. The use of both sets of parameters, namely the plurality of first and third obstacle parameters, ensures on the one hand that warning and automatic emergency braking is initiated even if no second measuring device is available. On the other hand, using the third obstacle parameters for calculating the time-to-collision achieves an earlier activation of a warning or an automatic emergency braking if a second measuring device is available.

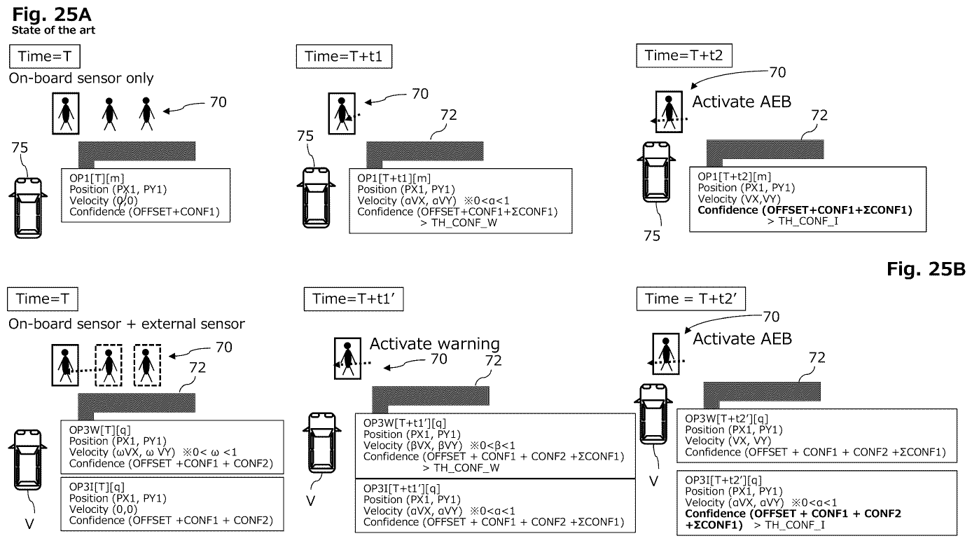

FIG. 25A schematically shows an example of a driver assistance performed using a control device other than the one depicted in FIG. 21, and FIG. 25B schematically shows an example of a driver assistance performed using the control device 1b depicted in FIG. 21.

In particular, FIG. 25A shows an example in which a warning and an automatic emergency braking (AEB) are subsequently executed only based on a plurality of first obstacle parameters determined by an on-board sensor of the vehicle, while FIG. 25B shows an example in which a warning and an automatic emergency braking (AEB) are subsequently executed based on a plurality of first and second obstacle parameters.

In both figures, a pedestrian 70, a boundary 72 (such as a wall or a building or the like) and a vehicle 75 (where V is used for FIG. 25B), having an on-board sensor 100 as first measuring device are depicted. The pedestrian 70 approaches a front of the vehicle 75 from an area behind the boundary 72 at a time T.

According to FIG. 25A, the on-board sensor of the vehicle determines first obstacle parameters OP1[T][m] at the time T when it detects the pedestrian 70 for the first time.

The position of the pedestrian at which he is determined for the first time by the on-board sensor is marked by a frame around the pedestrian. The first obstacle parameters OP1[T][m] include x- and y-coordinates of this position PX1, PY1 but do not include a velocity of the pedestrian 70, since at this time no previous position of him is known, based on which his velocity could be determined by the on-board sensor of the vehicle 75. The confidence indicator at the time T in FIG. 25A includes a confidence of the first obstacle parameters CONF1 at the current time and an offset, that may depend, for example, on environmental conditions influencing the reliability of the received messages.

At a time T+t1, the on-board sensor of the vehicle 75 has determined the first obstacle parameters OP1[T+t1][n] at least one more time (indicated by a length of the dotted arrow attached to the frame around the pedestrian 70), now including the velocity of the pedestrian 70 in x- and y-direction VX, VY which is afflicted by a factor □□smaller than 1 indicating that a variance of the determined velocity is still high due to a limited number of measuring points. The confidence indicator CONF1 of the first obstacle parameters OP1[T+t1][n] has been increased at the time T+t1 by the number of times □CONF that the on-board sensor of the vehicle 75 has determined the first obstacle parameters of the pedestrian 70. In particular the confidence indicator is higher that a predetermined warning confidence threshold TH_CONF_W, so that a warning decision parameter can be determined with sufficient reliability based on the first obstacle parameters present at the time T+t1, and a warning can be activated by the warning enabling unit 105a.

At a time T+t2, the on board sensor of the vehicle 75 has observed the pedestrian 70 for a longer time (indicated by the increased length of the dotted arrow attached to the frame around the pedestrian 70) so that velocity VX1, VY1 of the pedestrian 70 can now be determined with suitable accuracy. Furthermore, the confidence indicator of the first obstacle parameters CONF1 has exceeded the predetermined intervention confidence threshold TM_CONF_1, so that an intervention decision parameter can be reliably calculated based on the first obstacle parameters OP1[T+t2][n] at the time T+t2, and an automatic emergency braking can be activated by the intervention enabling unit 105b.

On the contrary, FIG. 25B shows an example in which a warning and an automatic emergency braking (AEB) is subsequently executed based on a plurality of first and second obstacle parameters. In other words, FIG. 25B shows an example in which the plurality of first obstacle parameters is also determined by the on-board device/sensor 100 of the vehicle V, and additionally a plurality of second obstacle parameters is determined by an external sensor 102, such as the mobile device of the pedestrian 70. The external sensor can determine second obstacle parameters of the pedestrian 70 before the on-board sensor of the vehicle V has detected the pedestrian 70 for the first time at the time T. This is indicated by the dotted frames around the positions of the pedestrian 70 when he is still located in an area behind the boundary 72, which is not visible for the on-board sensor of the vehicle 75. The position of the pedestrian 70 at which the on-board sensor detects him for the first time is again marked by a solid frame around the pedestrian 70. At this time the pedestrian has been observed by the external sensor for a certain time, which is indicated by the length of the dotted arrow attached to the solid frame around the pedestrian 70.

According to FIG. 25B, the obstacle parameter calculation unit 104 of the control device 1b depicted in FIG. 21 determines a first plurality of third obstacle parameters for determining a warning decision parameter and a second plurality of third obstacle parameters for determining an intervention decision parameter. The first plurality of third obstacle parameters is based on the first and second obstacle parameters while the second plurality of third obstacle parameters is only based on the first obstacle parameters. This means that an intervention in an intervention in a driver's driving behaviour may be performed only based on the first obstacle parameters, which may preferably be determined by an on-board measuring device of the vehicle V. This ensures that in the case of an external measuring device being not one hundred percent reliable, the entire control of the driver assistance system may remain with the vehicle.

At the time T, the first plurality of third obstacle parameters OP3W[T][q] includes a position PX1, PY1 of the pedestrian 70, determined by the on-board sensor and a velocity VX, VY of the pedestrian 70 determined by the external sensor. The velocity is afflicted by a factor □ smaller than 1 indicating that a variance of the determined velocity is still high due to a limited number of measuring points. However, it is possible to provide a velocity of the pedestrian 70 at the first time the latter is recognized by the on-board sensor of the vehicle V. The confidence indicator at the time T in FIG. 25B includes a confidence of the first and second obstacle parameters CONF1, CONF2 at the current time and an offset, and is thus higher than the confidence indicator of FIG. 25A.

The second plurality of third obstacle parameters OP3I[T][q] only includes a position PX1, PY1 of the pedestrian 70, determined by the on-board sensor. Since these third obstacle parameters are based only on the first obstacle parameters, a velocity of the pedestrian cannot be provided at the time T. However, the confidence indicator of the second plurality of third obstacle parameters is identical to that of the first plurality of third parameters OP3W[T][q] as the second obstacle parameters are available in both cases. That is why also a confidence of the second plurality of third obstacle parameters OP3I[T][q] increases faster as a confidence of the first obstacle parameters.

At a time T+t1′, the first obstacle parameters have been determined for at least one more time, so that the confidence indicator of the first and second plurality of third obstacle parameters OP3W[T+t1′][q] and OP3i[T+t1′][q] has been increased at the time T+t1′ by the number of times □CONF that the on-board sensor of the vehicle V has determined the first obstacle parameters of the pedestrian 70. Additionally, the variance of the velocity VX, VY included in the first plurality of third obstacle parameters OP3W[T+t1′][q] is decreased due to the increased observation time. The velocity is still afflicted by a factor □, which, however, may be higher than the factor □. The second plurality of third obstacle parameters now also includes a velocity calculated based on the first obstacle parameters determined by the on-board sensor of the vehicle V and afflicted by the factor □ smaller than the factor □. The confidence indicator of the first plurality of third obstacle parameters exceeds a predetermined warning confidence threshold TH_CONF_W at the time T+t1′, so that a warning decision parameter can be determined with sufficient reliability based the first plurality of third obstacle parameters OP3W[T+t1′][q] present at the time T+t1′, and a warning can be activated by the warning enabling unit 105a.

The time t1′ is smaller than the time t1, i.e. in the present case, the warning enabling unit 105a can enable a warning earlier than in the case depicted in FIG. 25A, where only the first obstacle parameters are used as bases for determining a warning decision parameter.

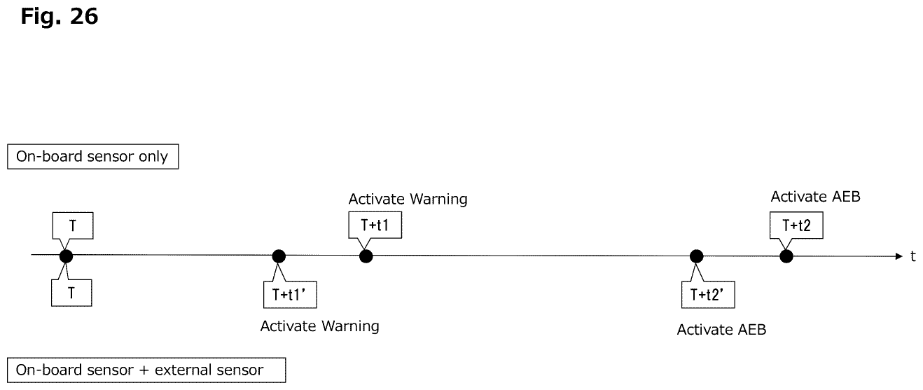

As the confidence indicator of the second obstacle parameters CONF2 is considered in the first and second plurality of third obstacle parameters OP3W[T+t2′][q] and OP3I[T+t2′][q], an automatic emergency braking can also be performed earlier than in FIG. 26a, namely at the time T+t2′.

At this time, the confidence indicator of the second plurality of third obstacle parameters exceeds the intervention confidence threshold TH_CONF_I, so that a intervention decision parameter can be determined with sufficient reliability based the second plurality of third obstacle parameters OP3I[T+T2′][q] present at the time T+t2′, and automatic emergency braking can be activated by the intervention enabling unit 105b.

FIG. 26 schematically shows a result of the driver assistance examples shown in FIGS. 25A and 25B in the form of a time line t on which the relevant points in time T, T+t1, T+t1′, T+t2, T+t2′ from the first observation at the time T to the activation of the automatic emergence braking at the times T+t2, T+t2′ are marked. Here, the time points of the example where only an on-board sensor was used are shown above the time line and the time points of the example where an on-board and an external sensor were used are shown below the time line.

It can be seen that the combination of an on-board sensor 100 and an external sensor 102 allows an earlier triggering of a warning as well as an earlier triggering of an automatic emergency braking (AEB) compared to the use of only an on-board sensor 100. This even applies to the parameter determination for automatic emergency braking, where no parameters of the external sensor 102 were used at all. However, since these parameters are available to activate a warning, they also increase the reliability of the parameters used for emergency braking.

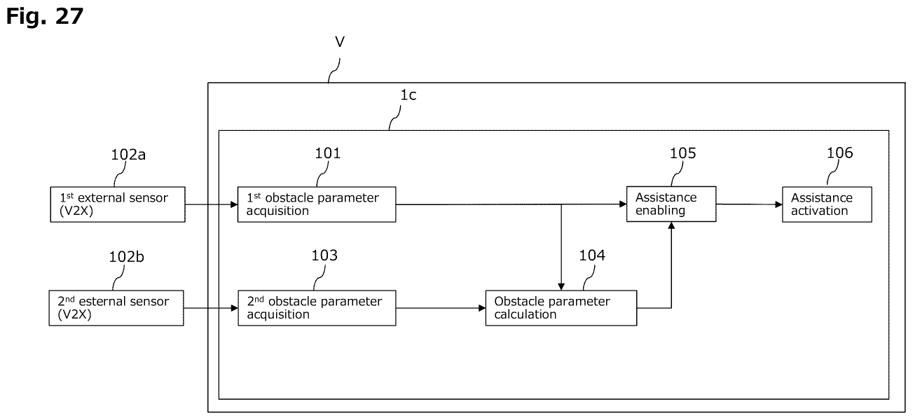

FIG. 27 schematically shows a control device 1c according to another example of the disclosed subject matter. The control device of FIG. 27 differs from that depicted in FIG. 1 by the fact that the first and the second measuring device are external sensors 102a, 102b, i.e. both sensors are positioned outside the vehicle V. In this case, an external sensor 102a, 102b located closer to the vehicle V may serve as first measuring device and an external sensor 102a, 102b located farther from the vehicle V may serve as second measuring device. Thus, the external sensor 102a, 102b closer to the vehicle has a shorter latency period than the external sensor 102a, 102b further away. On the other hand, the external sensor 102a, 102b located further away from the vehicle can detect an obstacle earlier than the external sensor 102a, 102b located closer thereto. One can further see, that the two external sensors 102a, 102b provide their data to the respective first/second obstacle parameter acquisition unit 101, 103 inside the control device 1c.

For example, a road side unit right (e.g. a camera) next to the vehicle may serve as first measuring device and a smartphone of a pedestrian may serve as second measuring device, in a case where the pedestrian with the smartphone appears as obstacle in the surroundings of the vehicle. The control device 1c may receive a signal from each the external sensor 102a, 102b and decide, for example, which of the external sensor 102a, 102b should act as the first and second measuring device depending on the signal strength. Subsequently, the obstacle parameter calculating unit 104 may receive the first and second obstacle parameters from both external sensors 102a, 102b (preferably via the first/second obstacle parameter acquisition unit 101, 103 as explained before) and calculate the third obstacle parameters based on the most reliable parameters thereof.

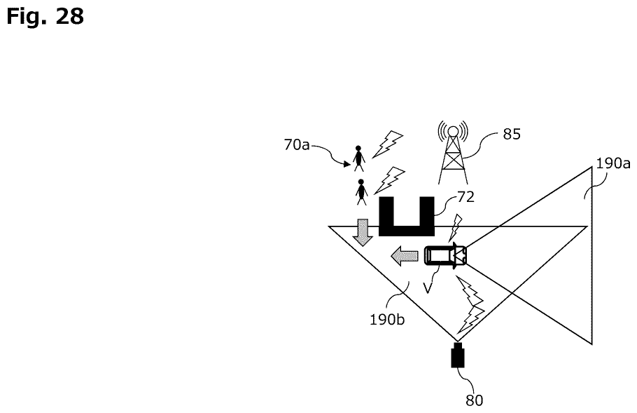

FIG. 28 schematically shows an example of a driver assistance when an obstacle is detected using the control device 1c depicted in FIG. 27. In particular, FIG. 28 shows a vehicle V, a road side unit 80, a boundary 72 (a wall, a building or the like), a pedestrian 70a and a cellular base station 85. The pedestrian 70a is carrying a mobile device sending and receiving GNSS based messages via the cellular network provided by the cellular base station 85 (indicated by the two lightning icons depicted between the cellular base station 85 and the pedestrian). The cellular network also reaches the vehicle V (indicated by the lightning icon between the cellular base station 85 and the vehicle V) so that the mobile device of the pedestrian 70a can exchange messages with the vehicle V.

The pedestrian 70a approaches a vicinity the vehicle V from an area behind the boundary 72 which is out of view of the vehicle V. The vehicle V is moving backwards, so a field of view 190a of its onboard sensor is pointing in the wrong direction, and thus cannot be used as the first measuring device. However, the road side unit 80 is positioned next to the vehicle V, so that a fast communication with the control device 1c, which may be located in the vehicle V, is ensured (indicated by the two lightning icons between the road side unit 80 and the vehicle V). Further, the road side unit is able to detect an obstacle in the surroundings of the vehicle V due to its field of view 190b capturing the entire area surrounding the vehicle. Therefore, the road side unit can serve as a first measuring device providing the position parameters of the pedestrian 70a while the pedestrian's mobile device may serve as second measuring device providing the movement parameters of the pedestrian 70a. In this way the third obstacle parameters of the pedestrian 70a may be reliably calculated by the obstacle parameter calculation unit 104 of the control device, based on a plurality of first obstacle parameters received from the road side unit 80 and a plurality of second obstacle parameters received from the pedestrian's mobile device.

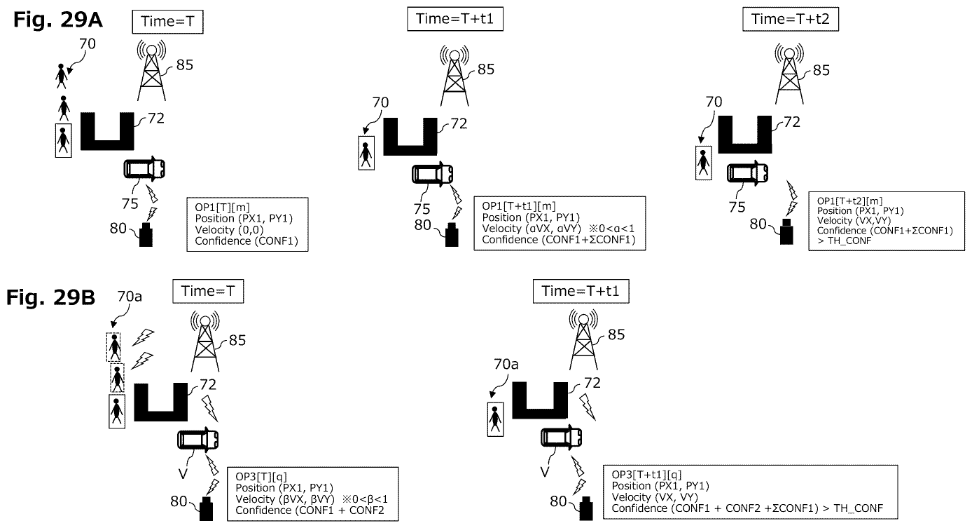

FIG. 29A and FIG. 29B schematically show an example of driver assistance performed using a control device other than the one depicted in FIG. 27 compared to an example of driver assistance performed using the control device 1c depicted in FIG. 27. Both figures show the situation already depicted in FIG. 28, in which a vehicle 75/V is moving backwards and a pedestrian 70, 70a is approaching the back of the vehicle 75/V from an area behind the boundary 72.

In particular, FIG. 29A shows an example in which only the plurality of first obstacle parameters is determined by the road side unit 80 and the mobile device of the pedestrian 70 is not used as second measuring device (indicated by the missing lightning icons between the cellular base station 85 and the pedestrian 70). At a time T, at which the road side unit 80 recognizes the pedestrian 70 for the first time, the latter determines a position PX1, PY1 of the pedestrian. The position at which the road side unit 80 detects the pedestrian 70 for the first time is marked by a frame around the pedestrian 70. The velocity of the pedestrian 70 is determined to 0 by the road side unit 80 at the time T, since no previous position of the pedestrian 70 is known at that time based on which his velocity could be determined. Thus the confidence indicator CONF1 of the first obstacle parameters OP1[T][n] is low at the time T.

At a time T+t1, the road side unit 80 has determined the first obstacle parameters OP1[T+t1][n] at least one more time, now including the velocity of the pedestrian 70 in x- and y-direction VX, VY which is afflicted by a factor □ indicating that the velocity VX, VY has low confidence. The confidence indicator CONF1 of the first obstacle parameters OP1[T+t1][n] has been increased at the time T+t1 by the number of times □CONF that the road side unit 80 has determined the first obstacle parameters of the pedestrian 70.

At a time T+t2, the road side unit 80 has observed the pedestrian 70 for a longer time so that a velocity VX1, VY1 of the pedestrian can now be determined with suitable accuracy. That is, the confidence indicator of the first obstacle parameters CONF1 has exceeded the first predetermined confidence threshold TM_CONF and a time-to-collision can be reliably calculated based on the first obstacle parameters OP1[T+t2][n] at the time T+t2.

On the contrary, FIG. 29B shows an example in which the plurality of first obstacle parameters is determined by the road side unit 80, and additionally a plurality of second obstacle parameters is determined by the mobile device of the pedestrian 70a.

In this case, the control device 1c has already calculated a plurality of third obstacle parameters OP3[T][q] at the time T including the position PX1, PY1 of the pedestrian 70a, which has been determined by the road side unit 80, and the velocity VX, VY of the pedestrian 70a, which has been determined by the pedestrians mobile device. To indicate that the pedestrian 70a has been already observed before the road side unit 80 detects him for the first time, the previous positions of the pedestrian are marked with a dotted frame. The velocity is afflicted by a factor □ smaller than 1 indicating that a variance of the determined velocity is still high due to a limited number of measuring points. However, it is possible to provide a velocity of the pedestrian 70a at the first time the latter is recognized by the road side unit 80. To indicate that the pedestrian 70a has already been observed by his mobile device before being detected for the first time by the road side unit 80, the previous positions of the pedestrian are marked with a dotted frame.

As the third obstacle parameters are calculated based on the position parameters of the first obstacle parameters and the movement parameters of the second obstacle parameters, the confidence indicator considers a confidence CONF1, CONF2 of the first and second obstacle parameters, and is thus higher than the confidence indicator CONF1 at the time T in FIG. 29A.

At a time T+t1, the road side unit 80 has determined the first obstacle parameters OP1[T+t1][n] at least one more time, so that the confidence indicator CONF1+CONF2 is increased by the number of times CONF that the road side unit 80 has determined the first obstacle parameters of the pedestrian 70. The value of the confidence indicator has therefore already exceeded the predetermined threshold TH_CONF at the time T+t1. Consequently, a time-to-collision can already be reliably calculated based on the third obstacle parameters OP3[T+t1][n] at the time T+t1.

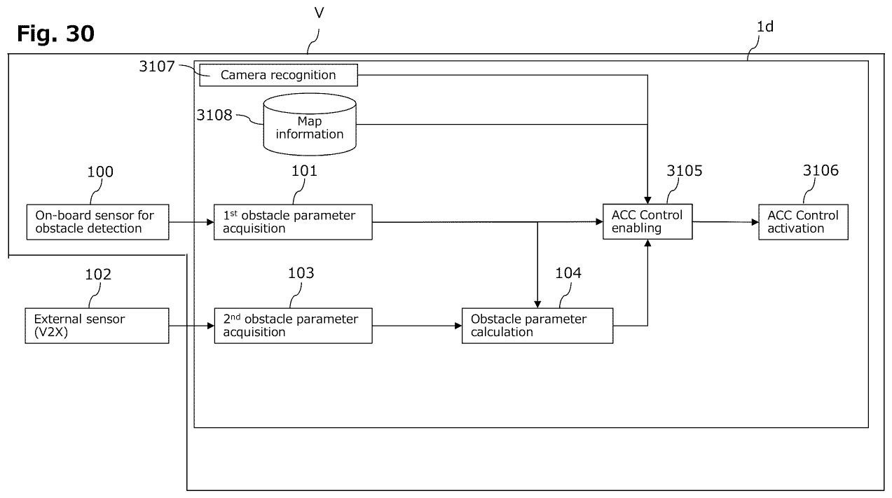

FIG. 30 schematically shows a control device 1d according to another example of the disclosed subject matter. The control device of FIG. 30 differs from that depicted in FIG. 1 by the fact that the enabling unit 3105 and the activation unit 3105 enable/activate an adaptive cruise control ACC, and that the control device 1d therefore additionally comprises a camera recognition unit 3107 and a map information storage 3108. However, these units may also be provided outside the control device 1d, and inside or outside the vehicle V.

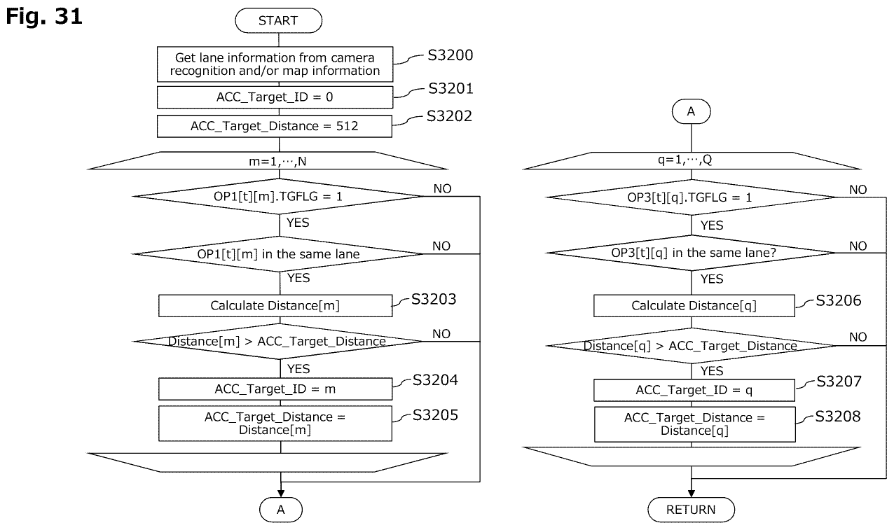

FIG. 31 shows a flowchart describing an example of a control process carried out by the control device 1d shown in FIG. 30. In particular, an ACC control enabling/activation by the control device of FIG. 30 is described in FIG. 31. After starting the process, in step S3200, the enabling unit of the ACC control 3105 may receive lane information from the camera recognition unit 3107. Alternative or in addition, the ACC control enabling unit 3105 may determine the lane information from map information provided in the map information storage 3108. Next, in step S3201 an ACC_Target_ID is set to 0, which means that the vehicle may follow a vehicle in front. In the following step S3202, a target distance ACC_Target_Distance to the vehicle in front is set to 512.

In the following calculation loop, the ACC control enabling unit 3105 of the control device 1d shown in FIG. 30 checks whether the confidence flag TGFLG=1 is set for each of the plurality of first obstacle parameters m=1, . . . , N, and whether the preceding vehicle providing the plurality of first obstacle parameters is in the same lane as the vehicle. If this is the case, a distance to the preceding vehicle is calculated by the ACC control enabling unit 3105 in step S3203, and it is verified whether the calculated distance is larger than an target distance ACC_TARGET_DISTANCE. In case of a positive result, the value of the ACC_Target_ID is set to constant speed m, which may be set by a driver, and the target distance ACC_Target_Distance is set to the distance calculated in step S3203.

In case that any of the above-described checks is negative, the process leaves the present calculation loop and proceeds further to a second calculation loop wherein the ACC_Target_ID and the target distance are calculated based on the plurality of third obstacle parameters.

According to the first calculation loop, it is firstly checked in the second calculation loop whether the confidence flag TGFLG =1 is set for each of the plurality of third obstacle parameters q=1, . . . , Q, and whether the vehicle in front providing the plurality of third obstacle parameters is in the same lane as the vehicle. If this is the case, a distance to the vehicle in front is calculated by the ACC control enabling unit 3105 in step S3206, and it is verified whether the calculated distance is larger than an target distance ACC_TARGET_DISTANCE. In case of a positive result, the value of the ACC_Target_ID is set to constant speed q, which may be set by a driver, and the target distance ACC_Target_Distance is set to the distance calculated in step S3206.

In case that any of the above-described checks is negative, the process leaves the second calculation loop and returns to step S3200 for repeating the process until a distance is calculated by the ACC control enabling unit 3105 which is larger than the target distance ACC_Target_Distance.

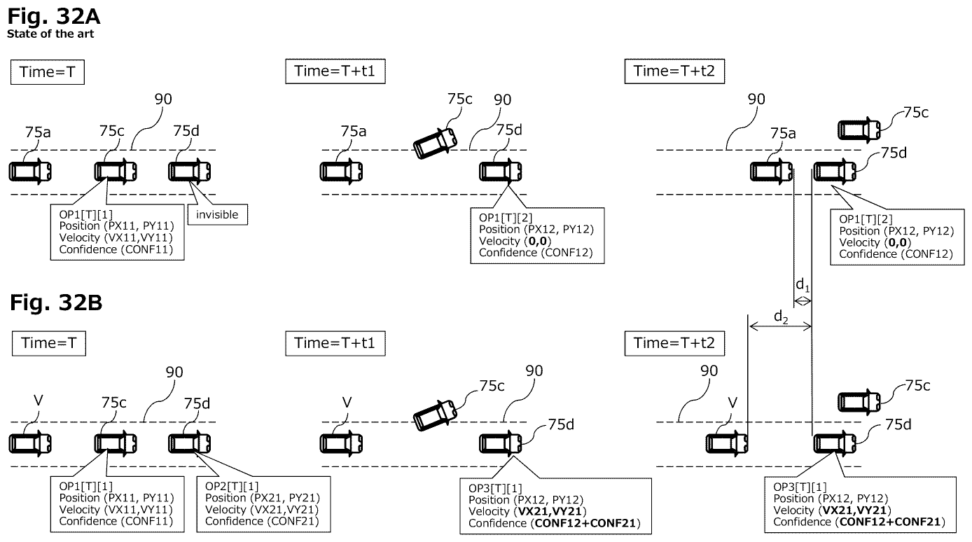

FIGS. 32A and 32B schematically show an example of driver assistance performed using a control device other than the one depicted in FIG. 30 compared to an example of driver assistance performed using the control device 1d depicted in FIG. 30.

In particular, FIG. 32A shows ACC control based only on a plurality of first obstacle parameters provided by a vehicle 75c traveling in a lane 90 ahead of the vehicle 75a performing ACC control (host vehicle). In front of the vehicle 75c, a slow vehicle 75d is travelling, which is not visible for the ACC control of the host vehicle 75a.

At a time T, the plurality of first obstacle parameters OP1[T][1] received by the host vehicle 75a include a position PX11, PY1 and a velocity VX11, VY11 from the vehicle 75c ahead. At this time, the confidence indicator CONF11 of the first obstacle parameters depends only on the parameters currently received at the time T.

At a time T+t1, the vehicle 75c overtakes the slow vehicle 75d, so that the slow vehicle is now the vehicle providing the plurality of first obstacle parameters OP1[T][2]. Since the slow vehicle 75d has not been visible for the host vehicle yet, the first obstacle parameters OP1[T][2] at the time T+t1 does not include a velocity of the slow vehicle 75d. Thus, lead to a lower confidence indicator CONF12 at the time T+t1 as the latter can only rely at the current first obstacle parameters OP1[T][2], which do not include information about the velocity of the vehicle 75d now in front of the host vehicle 75a.

Due to the lack of velocity information, the host vehicle 75a may not be able to maintain the target distance d2 from the slow vehicle 75d ahead and may have to perform heavy braking at a time T+t2 to maintain at least a small distance d1 from the slow vehicle 75d in front and avoid a collision.

To the contrary, FIG. 32B shows ACC control based on a plurality of first and second obstacle parameters, wherein the host vehicle V also receives the first obstacle parameters OP1[T][1] at a time T from the vehicle 75c traveling in the lane 90 ahead. The second obstacle parameters OP2[T][1] at that time are provided by the slow vehicle 75d driving in the lane 90 in front of the vehicle 75c. Thus, at the time T, the host vehicle knows the positions PX11, PY11, PX21, PY21 and the velocities VX11, VY11, VX21, VY21 from both vehicles 75c and 75d in front.

When the vehicle 75c overtakes the slow vehicle 75d at the time T+t1, the ACC control of the host vehicle V can calculate third obstacle parameters OP3[T][1] based on a current position PX12, PY12 of the slow vehicle 75d provided in its first obstacle parameters, and a velocity of the slow vehicle VX21, VY21 already determined at the time T and provided as second obstacle parameter.

Thus, the confidence indicator at the time T+t1 can rely on the confidence of the first and second obstacle parameters CONF12+CONF21. Having a velocity information at the time T+t1, the host vehicle is able to maintain the target distance de to the slow vehicle at the time T+t2 without the need for an emergency brake, so that the driving comfort is increased when using ACC control.

Summarizing, a method, a device and/or computer program product can be provided which in particular increase the driving comfort of a driver of a vehicle which makes use of the method/device or computer program product because sudden interventions of the driver assistance can be reduced or avoided.

It is furthermore noted that examples of the present disclosure may take the form of an entirely hardware example, an entirely software example (including firmware, resident software, micro-code, etc.), or an example combining software and hardware aspects. Furthermore, examples of the present disclosure may take the form of a computer program product on a computer-readable medium having computer-executable program code embodied in the medium.

It should be noted that arrows may be used in drawings to represent communication, transfer, or other activity involving two or more entities. Double-ended arrows generally indicate that activity may occur in both directions (e.g., a command/request in one direction with a corresponding reply back in the other direction, or peer-to-peer communications initiated by either entity), although in some situations, activity may not necessarily occur in both directions.

Single-ended arrows generally may indicate activity exclusively or predominantly in one direction, although it should be noted that, in certain situations, such directional activity actually may involve activities in both directions (e.g., a message from a sender to a receiver and an acknowledgement back from the receiver to the sender, or establishment of a connection prior to a transfer and termination of the connection following the transfer). Thus, the type of arrow used in a particular drawing to represent a particular activity is exemplary and should not be seen as limiting.

Aspects/examples are described hereinabove with reference to flowchart illustrations and/or block diagrams of methods and apparatuses and the like. It will be understood that each block of the flowchart illustrations and/or block diagrams, and/or combinations of blocks in the flowchart illustrations and/or block diagrams can be implemented by computer-executable program code.

The computer-executable program code may be provided to a processor of a general purpose computer, special purpose computer, or other programmable data processing apparatus to produce a particular machine, such that the program code, which executes via the processor of the computer or other programmable data processing apparatus, create means for implementing the functions/acts/outputs specified in the flowchart, block diagram block or blocks, figures, and/or written description.

These computer-executable program code may also be stored in a computer-readable memory that can direct a computer or other programmable data processing apparatus to function in a particular manner, such that the program code stored in the computer readable memory produce an article of manufacture including instruction means which implement the function/act/output specified in the flowchart, block diagram block(s), figures, and/or written description.

The computer-executable program code may also be loaded onto a computer or other programmable data processing apparatus to cause a series of operational steps to be performed on the computer or other programmable apparatus to produce a computer-implemented process such that the program code which executes on the computer or other programmable apparatus provides steps for implementing the functions/acts/outputs specified in the flowchart, block diagram block(s), figures, and/or written description. Alternatively, computer program implemented steps or acts may be combined with operator or human implemented steps or acts in order to carry out an embodiment.

Communication networks generally may include public and/or private networks; may include local-area, wide-area, metropolitan-area, storage, and/or other types of networks; and may employ communication technologies including, but in no way limited to, analogue technologies, digital technologies, optical technologies, wireless technologies (e.g., Bluetooth), networking technologies, and internetworking technologies.

It should also be noted that devices may use communication protocols and messages (e.g., messages created, transmitted, received, stored, and/or processed by the device), and such messages may be conveyed by a communication network or medium.

Unless the context otherwise requires, the present disclosure should not be construed as being limited to any particular communication message type, communication message format, or communication protocol. Thus, a communication message generally may include, without limitation, a frame, packet, datagram, user datagram, cell, or other type of communication message.

Unless the context requires otherwise, references to specific communication protocols are exemplary, and it should be understood that alternative embodiments may, as appropriate, employ variations of such communication protocols (e.g., modifications or extensions of the protocol that may be made from time-to-time) or other protocols either known or developed in the future.

It should also be noted that logic flows may be described herein to demonstrate various aspects and should not be construed to limit the disclosure to any particular logic flow or logic implementation. The described logic may be partitioned into different logic blocks (e.g., programs, modules, functions, or subroutines) without changing the overall results.

Often times, logic elements may be added, modified, omitted, performed in a different order, or implemented using different logic constructs (e.g., logic gates, looping primitives, conditional logic, and other logic constructs) without changing the overall results.

The present disclosure may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof Computer program logic implementing some or all of the described functionality is typically implemented as a set of computer program instructions that is converted into a computer executable form, stored as such in a computer readable medium, and executed by a microprocessor under the control of an operating system. Hardware-based logic implementing some or all of the described functionality may be implemented using one or more appropriately configured FPGAS.

Computer program logic implementing all or part of the functionality previously described herein may be embodied in various forms, including, but in no way limited to, a source code form, a computer executable form, and various intermediate forms (e.g., forms generated by an assembler, compiler, linker, or locator).

Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code maybe converted (e.g., via a translator, assembler, or compiler) into a computer executable form.

Computer-executable program code for carrying out operations of embodiments of the present disclosure may be written in an object oriented, scripted or unscripted programming language such as Java, Perl, Smalltalk, C++, or the like. However, the computer program code for carrying out operations of embodiments may also be written in conventional procedural programming languages, such as the “C” programming language or similar programming languages.

Computer program logic implementing all or part of the functionality previously described herein may be executed at different times on a single processor (e.g., concurrently) or may be executed at the same or different times on multiple processors and may run under a single operating system process/thread or under different operating system processes/threads.

Thus, the term “computer process” may refer generally to the execution of a set of computer program instructions regardless of whether different computer processes are executed on the same or different processors and regardless of whether different computer processes run under the same operating system process/thread or different operating system processes/threads.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device.

The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies.

The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Any suitable computer readable medium may be utilized. The computer readable medium may be, for example but not limited to, an electronic, magnetic, optical, electromagnetic, infrared, or semiconductor system, apparatus, device, or medium.

More specific examples of the computer readable medium include, but are not limited to, an electrical connection having one or more wires or other tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device.

The programmable logic may be fixed in a signal that is transmittable to a computer using any of various communication technologies, including, but in no way limited to, analogue technologies, digital technologies, optical technologies, wireless technologies (e.g., Bluetooth), networking technologies, and internetworking technologies.

The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web). Of course, some aspects may be implemented as a combination of both software (e.g., a computer program product) and hardware. Still other embodiments of the may be implemented as entirely hardware, or entirely software.

While certain exemplary aspects have been described and shown in the accompanying drawings, it is to be understood that such aspects are illustrative, and that the examples are not limited to the specific constructions and arrangements shown and described, since various other changes, combinations, omissions, modifications and substitutions, in addition to those set forth in the above paragraphs, are possible.

Those skilled in the art will appreciate that various adaptations, modifications, and/or combination of the just described embodiments can be configured. Therefore, it is to be understood that, within the scope of the appended claims, the disclosure may be practiced other than as specifically described herein. For example, unless expressly stated otherwise, the steps of processes described herein may be performed in orders different from those described herein and one or more steps may be combined, split, or performed simultaneously. Those skilled in the art will also appreciate, in view of this disclosure, that different examples or aspects described herein may be combined to form other examples.

### REFERENCE SIGNS LIST

100 on-board sensor for detecting obstacle
101 first obstacle parameter acquisition unit
102 external sensor
103 second obstacle parameter acquisition unit
104 obstacle parameter calculation unit
105 enabling unit
106 activation unit
800 map information storage
801 signal strength acquisition unit
802 specification acquisition unit
3107 camera recognition unit
3108 map information storage

1. A control device for controlling a driver assistance system of a vehicle comprising:
a first obstacle parameter acquisition unit configured to receive a plurality of first obstacle parameters of an obstacle in an area surrounding the vehicle that is detected by a first measuring device, the plurality of first obstacle parameters including one or more parameters of a first category and one or more parameters of a second category;
a second obstacle parameter acquisition unit configured to receive a plurality of second obstacle parameters of an obstacle in an area surrounding the vehicle that is detected by a second measuring device, the plurality of second obstacle parameters including one or more parameters of the first category and one or more parameters of the second category;
an obstacle parameter calculating unit configured to receive the plurality of first and second obstacle parameters from the first and the second obstacle parameter acquisition units, and to calculate a plurality of third obstacle parameters of the detected obstacle including one or more parameters of the first category and one or more parameters of the second category based on the plurality of first and second obstacle parameters, wherein
the obstacle parameter calculating unit is configured to calculate the one or more parameters of the first category based on the plurality of first obstacle parameters and the one or more parameters of the second category based on the plurality of second obstacle parameters;
an enabling unit configured to
to calculate a first decision parameter based on the plurality of third obstacle parameters, and
to enable a driver assistance if the first decision parameter is lower than a predetermined activation threshold.

2. The control device according to claim 1, wherein:
the obstacle parameter calculation unit is configured to determine if the first and second measuring device have detected the same obstacle based on a comparison of at least one of the plurality of first and second obstacle parameters, and to calculate the plurality of third obstacle parameters only if the determination is positive.

3. The control device according to claim 1, wherein:
the first measuring device is a measuring device being configured to communicate faster with the control device than the second measuring device, but to detect the obstacle later than the second measuring device; and
the second measuring device is a measuring device being configured to detect the obstacle earlier than the first measuring device, but to communicate slower with the control device than the first measuring device.

4. The control device according to claim 1, wherein:
a parameter of the first category is a position parameter of the obstacle including static information about the obstacle, and a parameter of the second category is a movement parameter of the obstacle including dynamic information about the obstacle.

5. The control device according to claim 1, wherein:
the obstacle parameter calculating unit includes a prediction model for calculating the plurality of third obstacle parameters configured to use the one or more parameters of the second category from the plurality of second obstacle parameters as one or more initial parameter to calculate the plurality of third obstacle parameters when the obstacle is detected for the first time.

6. The control device according to claim 1, wherein:
the obstacle parameter calculating unit is configured to calculate a confidence indicator expressing a confidence of the plurality of third obstacle parameters, and to send the calculated confidence indicator to the enabling unit together with the third obstacle parameters; and
the enabling unit is configured to enable the driver assistance if the first decision parameter is lower than the predetermined activation threshold and if a value of the confidence indicator is higher than a first predetermined confidence threshold.

7. The control device according to claim 1, wherein:
the enabling unit is configured to receive the plurality of first obstacle parameters from the first obstacle parameter acquisition unit,
to calculate a second decision parameter based on the plurality of first obstacle parameters, and
to enable the driver assistance if the first and/or the second decision parameter is lower than the predetermined activation threshold.

8. The control device according to claim 7, wherein:
the obstacle parameter calculating unit is configured to increase the value of the confidence indicator based on a number of times the obstacle is detected by the first measuring device.

9. The control device according to claim 7, wherein:
the obstacle parameter calculating unit is configured to calculate the confidence indicator considering a specification of the plurality of second obstacle parameters.

10. The control device according to claim 9, wherein:
the specification of the plurality of second obstacle parameters includes a plurality of specification parameters, and
the obstacle parameter calculating unit is configured to adjust the value of the confidence indicator based on a value of each specification parameter.

11. The control device according to claim 7, wherein:
the obstacle parameter calculating unit is configured to receive a plurality of map information of the area surrounding the vehicle, and to adjust the value of the confidence indicator based on the plurality of map information.

12. The control device according to claim 11, wherein:
the obstacle parameter calculating unit is configured to receive the plurality of second obstacle parameters detected by more than one second measuring devices,
to select the plurality of second obstacle parameters received from the more than one second measuring devices based on at least one of the plurality of specification parameters and at least one of the plurality of map information, and
to determine if an obstacle detected by one second measuring device is identical to an obstacle detected by another second measuring device based on at least one of the plurality of second obstacle parameters of the one and the other second measuring device,
if the determination is positive,
to receive the plurality of second obstacle parameters from at least one of the second measuring devices, and
if the determination is negative,
to receive the plurality of the second obstacle parameters detected by that one of the second measuring devices detecting an obstacle being identical to an obstacle detected by the first measuring device.

13. The control device according to claim 12, wherein:
the obstacle parameter calculating unit is configured to increase the value of the confidence indicator if the obstacles detected by the one and the other second measuring devices are identical, and
to decrease the value of the confidence indicator if the obstacles detected by the one and the other second measuring devices are different.

14. The control device according to claim 12, wherein:
the obstacle parameter calculating unit is configured to receive a field of view of the one and the other second measuring device, and
to decrease the value of the confidence indicator if the field of view of the one second measuring device overlaps with the field of view of the other second measuring device.

15. The control device according to claim 1, wherein:
the enabling unit comprises a warning enabling unit configured to calculate a warning decision parameter based on the plurality of third obstacle parameters, and
to enable a warning as driver assistance if the calculated warning decision parameter is lower than a predetermined warning threshold, and
an intervention enabling unit configured to calculate an intervention decision parameter based on the plurality of third obstacle parameters, and
to enable an intervention as driver assistance if the calculated intervention decision parameter is lower than a predetermined intervention threshold.

16. The control device according to claim 15, wherein:
if the confidence indicator is lower than a second predetermined confidence threshold,
the obstacle parameter calculating unit is configured to calculate a first plurality of third obstacle parameters and a second plurality of third obstacle parameters, wherein
the first plurality of third obstacle parameters is calculated based on the plurality of first obstacle parameters and the plurality of second obstacle parameters, and
the second plurality of third obstacle parameters is calculated only based on the plurality of first obstacle parameters; and
the warning enabling unit is configured to calculate the warning decision parameter based on the first plurality of third obstacle parameters, and
the intervention enabling unit is configured to calculate the intervention decision parameter based on the second plurality of third obstacle parameters; and
if the confidence indicator is higher than the second predetermined confidence threshold,
the obstacle parameter calculating unit is configured to calculate only the first plurality of third obstacle parameters, and
the warning enabling unit and the intervention enabling unit are configured to calculate the warning decision parameter and the intervention decision parameter, respectively, based on the first plurality of third obstacle parameters.

17. Method for controlling a driver assistance system for a vehicle comprising the steps of:
determining a plurality of first obstacle parameters of a detected obstacle, the obstacle detected by a first measuring device, including one or more parameters of a first category and one or more parameters of a second category;
determining a plurality of second obstacle parameters of the detected obstacle, the obstacle detected by a second measuring device, including one or more parameters of the first category and one or more parameters of the second category;
receiving the plurality of first and second obstacle parameters by an obstacle parameter calculating unit;
calculating a plurality of third obstacle parameters of the detected obstacle by the obstacle parameter calculating unit, the plurality of third obstacle parameters including one or more parameters of the first category and one or more parameters of the second category based on the plurality of first and second obstacle parameters, wherein the one or more parameters of the first category are calculated based the plurality of first obstacle parameters and the one or more parameter of the second category are calculated based on the plurality of second obstacle parameters;
calculating a decision parameter based on the plurality of third obstacle parameters, and
enabling a driver assistance if the decision parameter is lower than a predetermined threshold by the enabling unit.

18. A computer program product storable in a memory comprising instructions which, when carried out by a computer, cause the computer to perform the method according to claim 17.
